(19) United States
(12) Patent Application Publication
(10) Pub. No.: US 2020/0264527 A1
(43) Pub. Date: Aug. 20, 2020

(54) ELECTROSTATIC IMAGE DEVELOPING TONER AND IMAGE FORMING METHOD

(71) Applicant: Konica Minolta, Inc., Tokyo (JP)

(72) Inventors: Kouji SUGAMA, Tokyo (JP); Seijiro TAKAHASHI, Tokyo (JP); Haruo HORIGUCHI, Tokyo (JP); Yukiko KUSANO, Toyohashi-shi (JP); Toyoko SHIBATA, Tokyo (JP)

(21) Appl. No.: 16/713,866

(22) Filed: Dec. 13, 2019

(30) Foreign Application Priority Data
Feb. 19, 2019 (JP) 2019-027044

(51) Int. Cl. G03G 9/087

(52) U.S. Cl. CPC G03G 9/08711; G03G 9/08795

(57) ABSTRACT

Provided is an electrostatic image developing toner containing toner particles, wherein the toner particles contain a compound (A) that undergoes a phase transition from a solid to a liquid by absorbing light, or contain a polymer (A′) containing a structural unit derived from the compound (A); and a part or all of a site derived from the compound (A) is included in a domain in the toner particle and exists as a domain

### CROSS-REFERENCE TO RELATED APPLICATION

The entire disclosure of Japanese Patent Application No. 2019-027044, filed on Feb. 19, 2019 with Japan Patent Office, is incorporated herein by reference in its entirety.

### BACKGROUND

### 1. Technological Field

The present invention relates to an electrostatic image developing toner and an image forming method. More particularly, the present invention relates to an electrostatic image developing toner and an image forming method capable of forming a toner image having high image strength in a fixing method by light irradiation.

### 2. Description of the Related Art

As the current image fixing method, heat fixing is the mainstream, but in order to improve operability (warming-up time: WUT), save energy, and expand the types of support media, a system that fixes with an external stimulus different from heat has been proposed. Among them, a light fixing system that is relatively easily adapted to an electrophotographic process and has no harmful effects caused by heating has been attracting attention.

Patent Document 1 (JP-A 2014-191078) discloses a developer containing a binder resin, a colorant, and a compound that undergoes a cis-trans isomerization reaction by light absorption and undergoes phase transition as an additive. In Patent Document 1, there is disclosed a method in which by irradiating light on a toner image transferred to a sheet, the compound undergoing phase transition by light absorption is melted, and then irradiated again to solidify the compound, thereby the toner image is fixed on a sheet. Patent Document 2 (JP-A 2014-191077) discloses an image forming apparatus in which a developer containing a compound that undergoes a cis-trans isomerization reaction and undergoes phase transition by light absorption is used.

### SUMMARY

However, the optical fixing systems disclosed in JP-A 2014-191078 and JP-A 2014-191077 have a problem that the productivity is low and the image strength of the obtained toner image is low.

The present invention has been made in view of the above problems and situations, and an object of the present invention is to provide a toner for developing an electrostatic image and an image forming method capable of forming a toner image having high image strength in a fixing method by light irradiation.

To achieve at least one of the above-mentioned objects according to the present invention, an electrostatic image developing toner that reflects an aspect of the present invention comprises toner particles, wherein the toner particles contain a compound (A) that undergoes a phase transition from a solid to a liquid by absorbing light, or contain a polymer (A′) containing a structural unit derived from the compound (A), and a part or all of a site derived from the compound (A) is included in a domain in the toner particle and exists as a domain

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic configuration diagram illustrating an image forming apparatus according to the present invention.

FIG. 2 is a partial enlarged view illustrating a peripheral configuration of an image forming unit, an irradiation unit, and a pressure bonding unit in FIG. 1.

### DETAILED DESCRIPTION OF THE EMBODIMENTS

Hereinafter, one or more embodiments of the present invention will be described by referring to the drawings. However, the scope of the invention is not limited to the disclosed embodiments.

By the above-mentioned means of the present invention, it is possible to provide an electrostatic image developing toner and an image forming method capable of forming a toner image having high image strength in a fixing method by light irradiation. The expression mechanism or action mechanism of the effect of the present invention is not clear, but it is presumed as follows.

As a representative material that absorbs light and softens (light phase transition) from a solid state, an azobenzene compound is known, and it is thought that the light phase transition of an azobenzene compound is caused by the collapse of the crystal structure due to cis-trans isomerization. However, it has been found that azobenzene compounds do not often have a crystal structure in the toner because of their high compatibility with binder resins such as styrene-acrylic resins and polyester resins. For this reason, the crystal structure is not destroyed by light irradiation, so that the decrease in melt viscosity due to cis-trans isomerization is small and the fixing strength does not sufficiently increase. On the other hand, in the present invention, a part or all of a site derived from the compound (A) that undergoes a phase transition from solid to liquid by absorbing light is contained in a domain and exists as a domain By being present as a domain, the crystal structure is broken by cis-trans isomerization by light irradiation, free volume is developed, and the melt viscosity of the binder resin is greatly reduced. Therefore, the toner of the present invention has a large decrease in melt viscosity due to light irradiation, and it becomes possible to obtain a sufficient fixing strength with a smaller energy.

An electrostatic image developing toner of the present invention comprises toner particles, wherein the toner particles contain a compound (A) that undergoes a phase transition from a solid to a liquid by absorbing light, or contain a polymer (A′) containing a structural unit derived from the compound (A), and a part or all of a site derived from the compound (A) is included in a domain in the toner particle and exists as a domain This feature is a technical feature common to or corresponding to each of the following embodiments.

As an embodiment of the present invention, in the observation image of the cross section of the toner particles, it is preferable that the area of the domain is in the range of 1 to 50% with respect to the cross-sectional area of the toner particles from the viewpoint that the decrease in melt viscosity upon light irradiation is large and the fixing strength may be further increased.

When the toner particles further contain a binder resin, and the binder resin contains a styrene-acrylic resin, the glass transition temperature and viscosity of the toner may be adjusted to an appropriate range, which is preferable in terms of improving the fixing strength.

It is preferable that the compound (A) is an azobenzene derivative in that the toner image may be easily melted or softened even with a lower energy irradiation.

The image forming method of the present invention is an image forming method using an electrostatic image developing toner, and the image forming method contains the steps of: forming a toner image with the electrostatic image developing toner on a recording medium; and irradiating the toner image with light to soften the toner image. Thereby, the range of decrease in melt viscosity due to light irradiation is large, and sufficient fixing strength may be obtained with smaller energy, and a toner image having high image strength may be formed.

When the wavelength of the light is in the range of 280 to 480 nm, this is preferable from the viewpoint that the compound (A) or the polymer (A′) in the toner particles undergoes phase transition by absorbing light, and will sufficiently soften the toner image.

The present invention and the constitution elements thereof, as well as configurations and embodiments, will be detailed in the following. In the present description, when two figures are used to indicate a range of value before and after “to”, these figures are included in the range as a lowest limit value and an upper limit value.

The electrostatic image developing toner of the present invention (hereinafter also referred to as “toner”) is an electrostatic image developing toner containing at least toner particles. The toner particles contain a compound (A) that undergoes a phase transition from a solid to a liquid by absorbing light, or contain a polymer (A′) containing a structural unit derived from the compound (A). In addition, a part or the whole of the site derived from the compound (A) is included in a domain in the toner particle and exists as a domain

### <Domain>

In the present invention, the “domain” is a region in which a part or the whole of the site derived from the compound (A) is present in an isolated and dispersed manner in the form of threads, islands or particles in a continuous phase (matrix) of the resin component constituting the toner particles, when the cross section of the toner particles is observed by the following measurement method. Moreover, in the present invention, the domain may be formed only with the said compound (A), and may be formed with a mixture with a resin other than the compound (A). Furthermore, in the present invention, “existing as a domain” means that the entire compound (A) may be contained in a domain and exist as a domain, or a part of the compound (A) may be present in the domain and exist as a domain.

In the observation image of the cross section of the toner particle, the area of the domain is preferably in the range of 1 to 50% with respect to the cross-sectional area of the toner particle, and more preferably in the range of 3 to 30%. When it is in the range of 1 to 50%, the decrease in melt viscosity at the time of light irradiation is large, and the fixing strength can be increased. As a method for measuring the area of the domain, an area of a domain-forming portion may be measured in an image obtained by the following method for observing a cross section of toner particles (magnification: 10,000 times).

### (Measurement Method)

The cross section of the toner particles may be observed with a transmission electron microscope, a scanning electron microscope, a scanning probe microscope (SPM), or the like. An example is given below, but the present invention is not limited to this as long as equivalent observations may be made.

### <<1. Method for Preparing a Section of Toner Particles>>

A toner is exposed for 10 minutes in a ruthenium tetroxide (RuO₄) vapor atmosphere, and then the toner is buried in a photocurable resin “D-800” (manufactured by JEOL Ltd.). A photo-cured block is formed by this. Then, using a microtome provided with diamond cutter, a thin sample having a thickness of 60 to 100 nm is cut out from the formed block. This thin sample is placed on a grid with a support membrane for transmission electron microscope observation. A filter paper is put on a plastic petri dish having a diameter of 5 cm (5 cmφ), and the grid having the section is placed on the plastic petri dish with the side on which the section is placed facing upward.

### <<2. Ruthenium Tetroxide Staining Conditions>>

When it is required, staining is performed. The staining conditions (time, temperature, concentration and amount of the staining agent) are adjusted so that each component (mainly an amorphous resin and a compound that undergoes phase transition) can be distinguished during observation with a transmission electron microscope. For example, 2 to 3 drops of 0.5 mass % RuO₄ staining solution is dropped on two points in the petri dish, covered, and after 10 minutes, the petri dish lid is removed and left until the staining liquid is free of moisture.

### <<3. Cross-Sectional Observation Method (Conditions) of Toner Particles>>

Apparatus: Scanning electron microscope “JSM-7401F” (manufactured by JEOL Ltd.);

Sample: Toner particle section (section thickness of about 100 nm); and

Observation conditions: Acceleration voltage 30 kV, transmission image mode, bright field image, magnification 10,000 times.

In the toner particles according to the present invention, in order for a part or all of the site derived from the compound (A) to exist as a domain, for example, it can be controlled by the method of adding the compound (A) to the toner particles, the production conditions such as temperature and time in the toner production process, and the composition of the binder resin. In particular, as a method for adding the compound containing the compound (A) to the toner particles, a method of using the mini-emulsion polymerization method and controlling the temperature in the toner production process is preferable. Specifically, in the toner particle preparation step, it can be cited a method including a step of stirring for 1 hour or more at a temperature of 30 to 70° C. after stopping the particle growth of the toner base particles. In the case of the polymer (A′) containing a structural unit derived from the compound (A), it can be made to exist as a domain by controlling production conditions such as temperature and time in the toner production process, resin composition and molecular weight distribution. Specifically, in the toner particle preparation step, it can be cited a method having a step of stirring for 2 hours or more at a temperature of 30 to 70° C. after stopping the particle growth of the toner base particles.

The toner of the present invention contains at least toner particles. In this specification, “toner particles” includes “toner mother particles” and additives added to the “toner mother particles”. The “toner mother particle” constitutes the base of the “toner particles”. The toner mother particles according to the present invention contain at least the compound (A) or the polymer (A′), and, if necessary, a binder resin, a colorant, and a releasing agent (wax), or other constituents such as a charge controlling agent may be contained. “Toner” refers to an aggregate of “toner particles”.

### <Compound (A)>

The compound (A) that undergoes a phase transition from solid to liquid by absorbing light is not particularly limited, but it is preferably a compound that undergoes a cis-trans isomerization reaction by light absorption. Examples of the compound that undergoes a cis-trans isomerization reaction include azobenzene derivatives, stilbene derivatives, and azomethine derivatives, and azobenzene derivatives are particularly preferable because they easily melt or soften a toner image even with a lower energy irradiation amount.

### (Azobenzene Derivative)

The azobenzene derivative according to the present invention is preferably an azobenzene derivative having a structure represented by the following Formula (1).

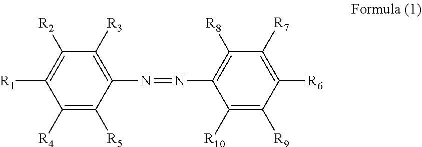

In Formula (1), R₁ to R₁₀ each independently represent a group selected from the group consisting of a hydrogen atom, an alkyl group, an alkoxy group, a halogen atom, a hydroxy group and a carboxy group. At least three of R₁ to R₁₀ represent a group selected from the group consisting of an alkyl group, an alkoxy group, a halogen atom, a hydroxy group and a carboxy group. At least one of R₁ to R₅ represents an alkyl group or an alkoxy group having 1 to 18 carbon atoms. And at least one of R₆ to R₁₀ represents an alkyl group or an alkoxy group having 1 to 18 carbon atoms.

Examples of the alkyl group include: straight-chain alkyl groups such as a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, and an n-hexadecyl group; and branched alkyl groups such as an isopropyl group, an isobutyl group, a sec-butyl group, a tert-butyl group, an isoamyl group, a tert-pentyl group, a neopentyl group, a 1-methylpentyl group, a 4-methyl-2-pentyl group, a 3,3-dimethylbutyl group, a 2-ethylbutyl group, a 1-methylhexyl group, a tert-octyl group, a 1-methylheptyl group, a 2-ethylhexyl group, a 2-propylpentyl group, a 2,2-dimethylheptyl group, a 2,6-dimethyl-4-heptyl group, a 3,5,5-trimethylhexyl group, a 1-methyldecyl group, and a 1-hexylheptyl group.

Examples of the alkoxy group include: straight-chain alkoxy groups such as a methoxy group, an ethoxy group, an n-propoxy group, an n-butoxy group, an n-pentyloxy group, an n-hexyloxy group, an n-heptyloxy group, an n-octyloxy group, an n-nonyloxy group, an n-decyloxy group, an n-undecyloxy group, an n-dodecyloxy group, an n-tridecyloxy group, an n-tetradecyloxy group, an n-pentadecyloxy group, and an n-hexadecyloxy group; and branched alkoxy groups such as an isopropoxy group, a tert-butoxy group, a 1-methylpentyloxy group, a 4-methyl-2-pentyloxy group, a 3,3-dimethylbutyloxy group, a 2-ethylbutyloxy group, a 1-methylhexyloxy group, a tert-octyloxy group, a 1-methylheptyloxy group, a 2-ethylhexyloxy group, a 2-propylpentyloxy group, a 2,2-dimethylheptyloxy group, a 2,6-dimethyl-4-heptyloxy group, a 3,5,5-trimethylhexyloxy group, a 1-methyldecyloxy group, and a 1-hexylheptyloxy group.

The halogen atom refers to a fluorine atom (—F), a chlorine atom (—Cl), a bromine atom (—Br) or an iodine atom (—I).

In Formula (1), R₁ and R₆ are preferably each independently an alkyl group or an alkoxy group having 1 to 18 carbon atoms. Among them, from the viewpoint of further improving the fixability of the image, R₁ and R₆ are preferably each independently an alkoxy group having 1 to 18 carbon atoms. Thus, having an alkyl group or alkoxy group having 1 to 18 carbon atoms at the para position of two benzene rings increases the thermal mobility of the molecule. And as described above, it is likely that the overall melting o will occur in sequence throughout the system. Although an alkyl group or an alkoxy group having 1 to 18 carbon atoms represented by R₁ and R₆ may be straight-chain or branched, from the viewpoint of forming the structure of rod-like molecules in which light phase transition is likely to occur, the straight-chain is preferable.

In particular, R₁ and R₆ are preferably each independently an alkyl group or an alkoxy group having 6 to 12 carbon atoms. When R₁ and R₆ are an alkyl group or an alkoxy group within the above-mentioned carbon number range, the alkyl-alkyl interaction acting between molecules is relatively weak while having high thermal mobility. Therefore, cis-trans isomerization is more likely to proceed, and the melting or softening rate by light irradiation and the fixation of the image are further improved.

R₁ and R₆ may be the same or different, but are preferably the same in terms of easiness of synthesis.

In Formula (1), at least one of R₂ to R₅ and R₇ to R₁₀ is a group selected from the group consisting of an alkyl group, an alkoxy group, a halogen group, a hydroxy group and a carboxy group (hereinafter referred to simply as “a substituent”). Having such a structure results in the formation of lattice defects that favor cis-trans isomerization, the appearance of free volume, and the reduction of 7E-7E interactions. Therefore, cis-trans isomerization is more likely to proceed, and the melting or softening rate by light irradiation and the fixation of the image are further improved. In particular, from the viewpoint of securing a free volume necessary for cis-trans isomerization, at least one of R₂ to R₅ and R₇ to R₁₀ is preferably an alkyl or alkoxy group having 1 to 4 carbon atoms which may have a branch or a halogen group. From the viewpoint of further improving the fixability of the image, an alkyl group having 1 to 4 carbon atoms is more preferable, and a methyl group is particularly preferable.

In Formula (1), the number of substituents in R₂ to R₅ and R₇ to R₁₀ is preferably 1 to 8, and more preferably 1 to 6. In particular, from the viewpoint of not lowering the melting point of the azobenzene derivative too much and further improving the heat resistant storage stability of the toner, the number of substituents is more preferably 1 to 4, and particularly preferably 1 to 3.

The position at which a substituent is present in R₂ to R₅ and R₇ to R₁₀ is not particularly limited, preferably, at least a substituent is present in any of R₂, R₄, R₇ and R₉ (in other words, the ortho position of R₁ and the ortho position of R₆) of Formula (1). Further preferably, a methyl group is present in any one of R₂, R₄, R₇ and R₉ of Formula (1). The azobenzene derivative having such a structure further improves the fixing property of the image since the melting or softening rate by light irradiation is further improved, and the melting point is appropriately increased, so that the heat resistant storage stability of the toner is also improved.

Preferable azobenzene derivatives according to the present invention are compounds derived from 4,4′-dialkyl azobenzene and 4,4′-bis(alkoxy) azobenzene. Examples thereof are derivatives of 4,4′ -dialkyl azobenzene having the same alkyl group of 1 to 18 carbon atoms as R₁ and R₆ in Formula (1) such as 4,4′-dihexylazobenzene, 4,4′-dioctylazobenzene, 4,4′-didecylazobenzene, 4,4′-didodecylazobenzene, and 4,4′-dihexadecylazobenzene. Another examples thereof are derivatives of 4,4′-bis(alkoxy)azobenzene having the same alkoxy group of 1 to 18 carbon atoms as R₁ and R₆ in Formula (1) such as 4,4′-bis(hexyloxy)azobenzene, 4,4′-bis(octyloxy)azobenzene, 4,4′-bis(dodecyloxy)azobenzene, and 4,4′-bis(hexadecyloxy) azobenzene. Preferable derivatives are compounds in which the hydrogen atom attached to the benzene ring is mono-, di- or tri-substituted by a group selected from the group consisting of alkyl group, alkoxy group, halogen group, hydroxy group and carboxy group. Specific examples of the compound (A) according to the present invention include the following compounds.

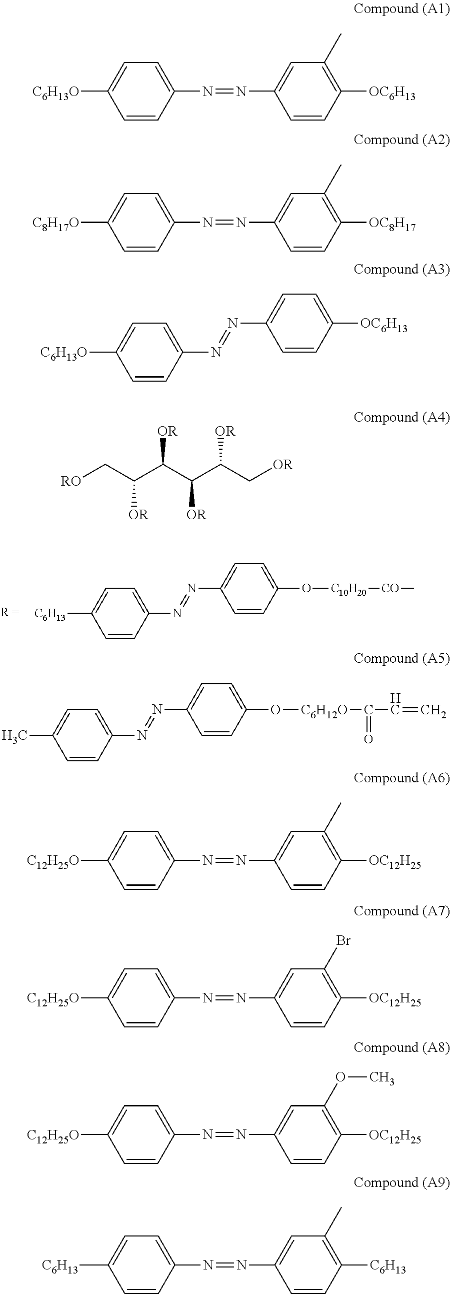

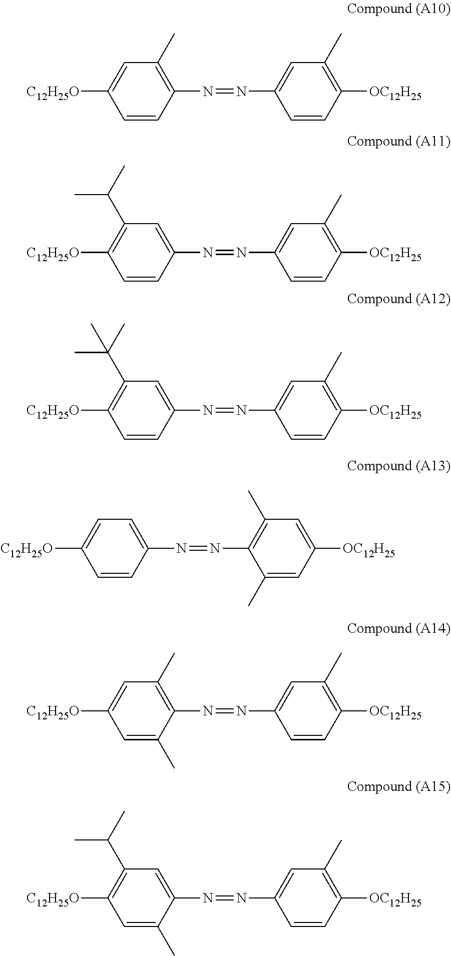

The synthetic method of the azobenzene derivative is not particularly limited, and conventionally known synthetic methods may be applied.

For example, as in the following reaction scheme A, 4-aminophenol is reacted with sodium nitrite under cooling to form a diazonium salt. This is reacted with o-cresol to synthesize intermediate A (first step), and then n-bromohexane is allowed to react with the intermediate A (second step). Thus, the above azobenzene derivative (A1) may be obtained.

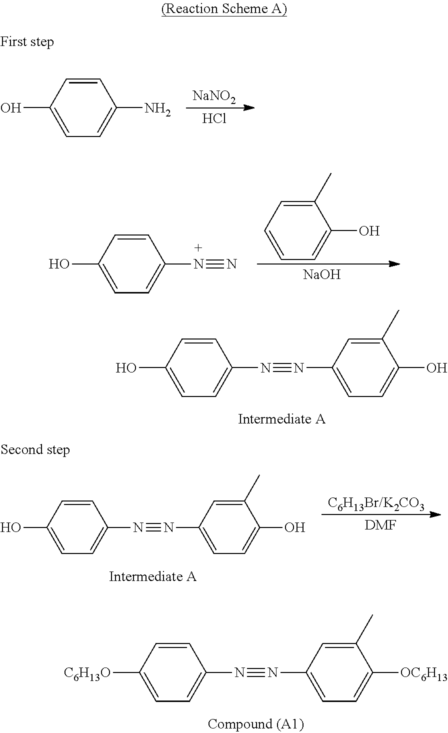

It is possible to obtain an azobenzene derivative in which R₁ and R₆ in Formula (1) are an alkoxy group by changing the raw materials (4-aminophenol, o-cresol and/or n-bromohexane) used in the above reaction scheme A to other compounds. Those skilled in the art may appropriately make the above changes to synthesize a desired azobenzene derivative. Moreover, when the above-described production method is used, the azobenzene derivative which has an asymmetrical structure may be obtained easily.

For example, as shown in the following reaction scheme B, the azobenzene derivative (A7) may be obtained by changing o-cresol and n-bromohexane to 2-bromophenol and n-bromododecane respectively.

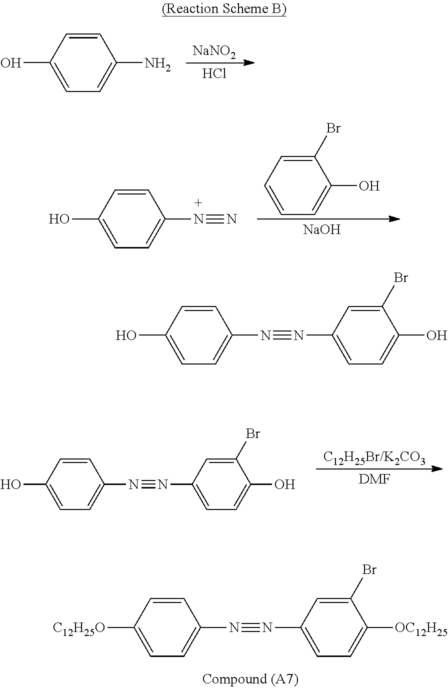

Further, as shown in the following reaction formula C, an azobenzene derivative compound (A8) can be obtained by reacting an azobenzene derivative compound (A7) with methanol in the presence of a Pd catalyst and a base.

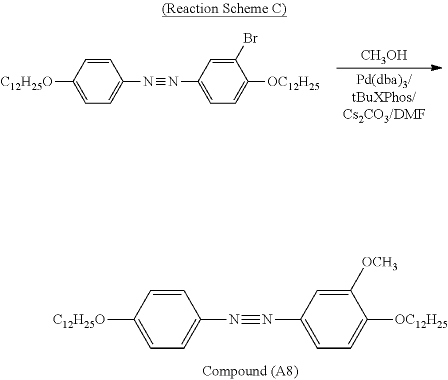

Alternatively, for example, as shown in the following reaction scheme D, manganese dioxide as an oxidizing agent is reacted with p-hexylaniline to synthesize 4,4′-dihexylazobenzene and then reacted with N-bromosuccinimide. An azobenzene derivative (A9) may be obtained by reacting methylboronic acid in the presence of a Pd catalyst and a base.

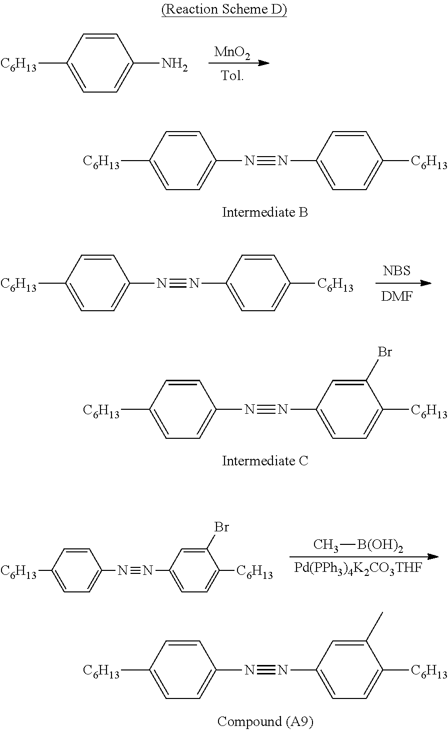

In the above reaction scheme D, the azobenzene derivative in which R₁ and R₆ in Formula (1) are alkyl groups is obtained by changing the starting material (p-hexylaniline and/or methylboronic acid) to another compound. A person skilled in the art can synthesize a desired azobenzene derivative by appropriately making the above changes.

These azobenzene derivatives may be used alone or in combination of two or more.

### <Polymer (A′)>

The polymer (A′) according to the present invention includes a structural unit derived from the compound (A). The polymer (A′) is preferably a polymer (B) containing a structural unit having an azobenzene group.

(Polymer (B) Containing a Structural Unit having an Azobenzene Group)

The polymer (B) containing a structural unit having an azobenzene group may be a polymer (B1) obtained by polymerizing an azobenzene derivative (b1-1) having a polymerizable group (azobenzene derivative monomer). It may be a polymer (B2) obtained by reacting a polymer (b2-1) containing a structural unit having a hydroxy group with an azobenzene compound (b2-2) having a functional group that reacts with the hydroxy group.

### About Polymer (B1):

The polymer (B1) contains a structural unit derived from the azobenzene derivative (b1-1) having a polymerizable group. The polymer (B1) is obtained by polymerizing a monomer composition containing an azobenzene derivative (b1-1) having a polymerizable group.

The number of polymerizable groups contained in one molecule of the azobenzene derivative (b1-1) having a polymerizable group may be one or two or more. Among them, from the viewpoint of easily obtaining a polymer that can be easily melted even with a low light irradiation energy amount, the number of polymerizable groups contained in one molecule of the azobenzene derivative (b1-1) having a polymerizable group is one. That is, it is preferably a monofunctional polymerizable monomer.

Examples of the polymerizable group include a (meth)acryloyl group, an epoxy group, and a vinyl group. Of these, a (meth)acryloyl group is preferable. The (meth)acryloyl group means an acityloyl group and a methacryloyl group.

That is, the azobenzene derivative (b1-1) having a polymerizable group preferably has a group represented by any of the following formulas (i) to (iii) as the group having a polymerizable group.

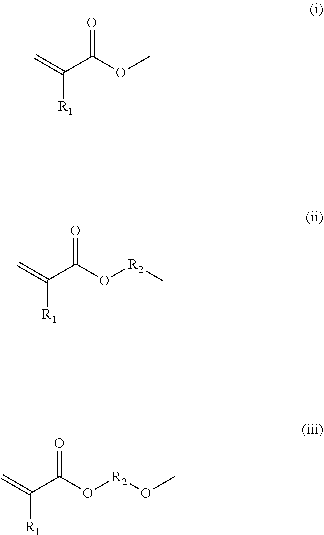

In Formulas (i) to (iii), R₁ is a hydrogen atom or a methyl group. R₂ is an alkylene group having 1 to 12 carbon atoms. The alkylene group having 1 to 12 carbon atoms is preferably an alkylene group having 3 to 10 carbon atoms. The alkylene group may be linear or branched, and linear is preferably. A part of the alkylene group may be substituted with a substituent. Examples of the substituent include a halogen group, a nitro group, a hydroxy group, and a carboxy group.

The azobenzene derivative (b1-1) having a polymerizable group is preferably represented by the following Formula (2).

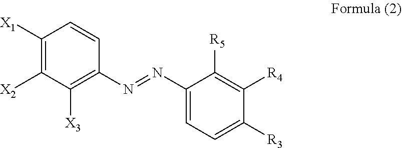

In Formula (2), any one of X₁ to X₃ is a group having a polymerizable group, and the rest are each a hydrogen atom. The group having a polymerizable group is preferably a group represented by any of the aforementioned Formulas (i) to (iii), and more preferably a group represented by Formula (iii).

R₃ to R₅ each are a hydrogen atom, a functional group containing a hetero atom, an alkyl group having 1 to 12 carbon atoms, or an alkoxy group having 1 to 12 carbon atoms. Examples of the functional group containing a hetero atom include a nitro group, a hydroxy group, and a carboxy group. The alkyl group having 1 to 12 carbon atoms and the alkoxy group having 1 to 12 carbon atoms are preferably an alkyl group having 1 to 4 carbon atoms and an alkoxy group having 1 to 4 carbon atoms, respectively. A part of the alkyl group or alkoxy group may be substituted with a substituent as described above.

In particular, when R₃ to R₅ are groups having a carbon chain that is too long or groups that easily interact with each other, in the polymer (B), R₃ to R₅ of different molecules may be easily entangled with each other or may easily interact with each other, and photoisomerization may not easily occur. From the viewpoint of avoiding such inconveniences, R₃ to R₅ are preferably groups having a relatively short carbon chain or a group that does not easily interact with each other, and are preferably a hydrogen atom, an alkyl group having 1 to 4 carbon atoms. More preferably, it is an alkoxy group having 1 to 4 carbon atoms.

In particular, from the viewpoint of facilitating photoisomerization and facilitating melting or softening of the toner image even by irradiation with light of lower energy, the azobenzene derivative (b1-1) having a polymerizable group is represented by the following Formula (3) is more preferable, and the following Formula (4) is particularly preferable.

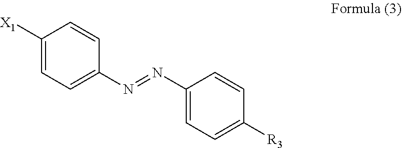

In Formula (3), X₁ and R₃ are respectively synonymous with X₁ and R₃ in Formula (2).

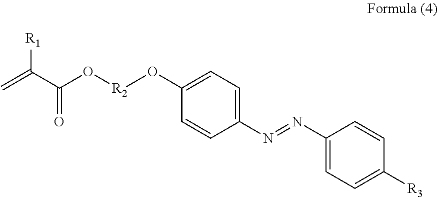

In Formula (4), X₁ and R₃ have the same meanings as X₁ and R₃ in Formula (2), respectively. In Formula (4), R₂ is synonymous with R₂ in Formulas (i) to (iii). In particular, in Formula (4), R₃ is preferably a hydrogen atom, an alkyl group having 1 to 4 carbon atoms, or an alkoxy group having 1 to 4 carbon atoms.

The polymer (B1) may further contain a structural unit derived from another monomer (b1-2) in addition to the structural unit derived from the azobenzene derivative (b1-1) having a polymerizable group. Examples of the other monomer (b1-2) include a styrene derivative.

Examples of the styrene derivative include styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecylstyrene.

The content of the structural unit derived from the other monomer (b1-2) is preferably 70 mass % or less with respect to 100 mass % of the total amount of all the structural units constituting the polymer (B1). More preferably, it is 40 mass % or less.

Specific examples of the polymer (B1) thus obtained (that is, the polymer (A′)) include the following. In the exemplified compounds of the polymer indicated below, n represents the degree of polymerization, and it is preferably in the range of 3 to 100.

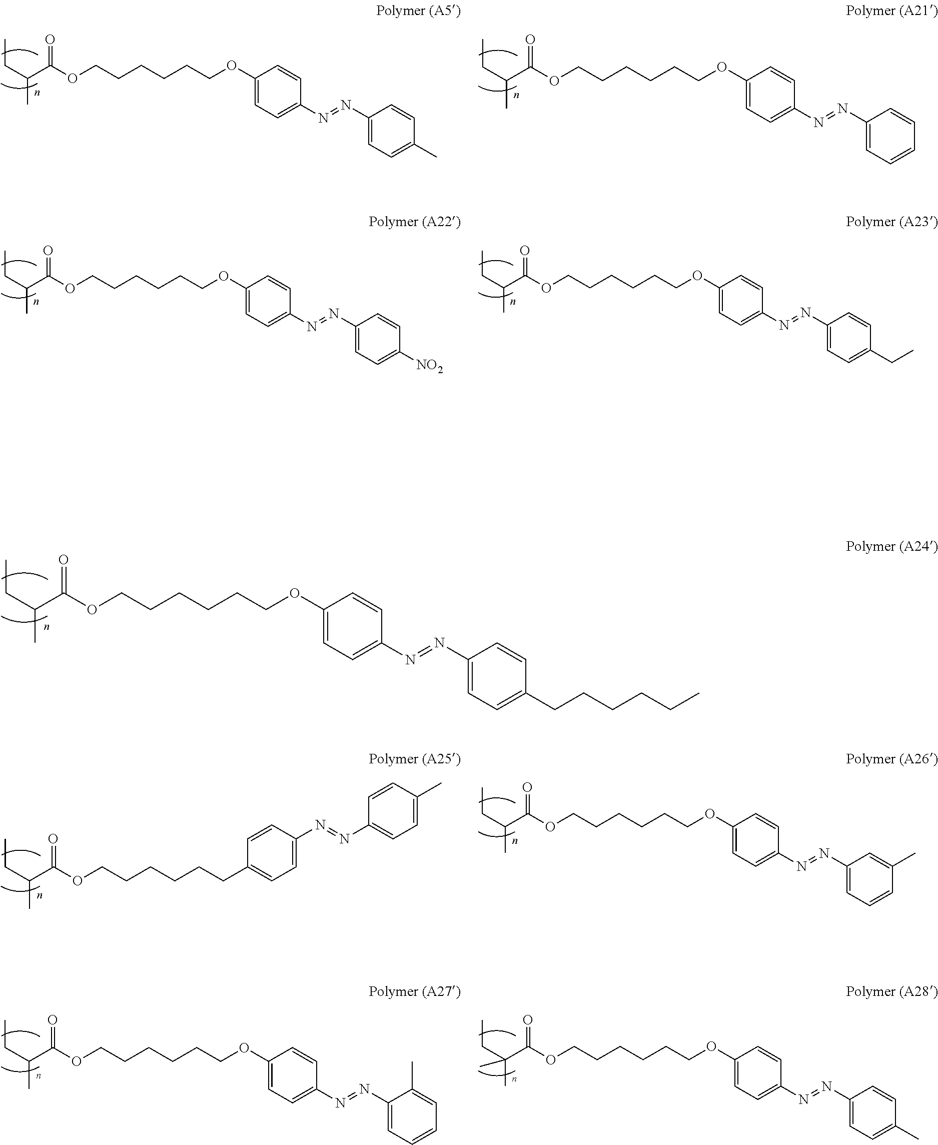

### About Polymer (B2):

As described above, the polymer (B2) is obtained by reacting the polymer (b2-1) containing a structural unit having a hydroxy group with the azobenzene compound (b2-2) having a functional group that reacts with the hydroxy group.

Examples of the polymer (b2-1) containing a structural unit having a hydroxy group include an epoxy resin (a polymer containing a structural unit derived from a ring-opened product of glycidyl ether), a polyvinyl alcohol resin, and a butyral resin (partially butyralized polyvinyl alcohol resin). Among these, polyvinyl alcohol resin is preferable.

The azobenzene compound (b2-2) having a functional group that reacts with a hydroxy group may be an azobenzene compound having an acyl halide group (as a functional group that reacts with a hydroxy group). The azobenzene compound having an acyl halide group may be, for example, a compound represented by the following Formula (5).

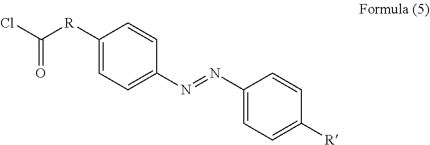

In Formula (5), R represents a single bond, an alkylene group, or an alkoxylene group (—RO—). R′ represents a hydrogen atom, a hydroxy group, a functional group containing a hetero atom, an alkyl group having 1 to 12 carbon atoms, or an alkoxy group having 1 to 12 carbon atoms.

The azobenzene compound represented by Formula (5) is obtained by, for example, reacting a hydroxyazobenzene compound with a halogen atom-containing carboxylic acid compound under alkaline conditions to obtain a carboxy group-containing azobenzene derivative, and then by reacting the carboxy group-containing azobenzene with acid halogenating agents.

The halogen atom-containing carboxylic acid compound is a compound having a carboxy group and a halogen atom, a halogen atom-containing carboxylic acid compound having 2 to 17 carbon atoms is preferable, and a halogen atom having 9 to 13 carbon atoms is more preferable.

Examples of the acid halogenating agent include thionyl chloride, oxalyl chloride, phosgene, phosphorus oxychloride, phosphorus pentachloride, phosphorus trichloride, thionyl bromide, phosphorus tribromide, and diethylaminosulfur trifluoride. Of these, thionyl chloride is preferable.

Specific examples of the polymer (B2) (that is, the polymer (A′)) thus obtained include the following.

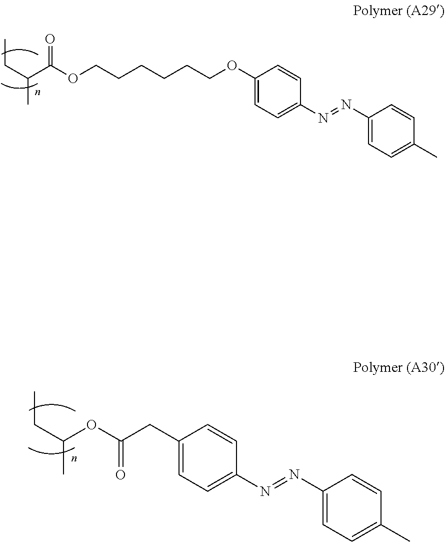

As described above, the polymer (B2) is obtained by reacting the polymer (b2-1) containing a structural unit having a hydroxy group with the azobenzene compound (b2-2) having a functional group that reacts with the hydroxy group. Therefore, some hydroxy groups are likely to remain unreacted, and all of the hydroxy groups may not be substituted with a group containing an azobenzene group. Therefore, from the viewpoint of facilitating the reliable introduction of azobenzene groups into the molecule and making it easy to obtain toner images with high fixability and image strength, the polymer (B) containing a structural unit having an azobenzene group is preferably a polymer (B1) obtained by polymerizing an azobenzene derivative (b1-1) having a polymerizable group.

The compound (A) is preferably contained in the range of 5 to 60 mass % with respect to the toner mother particles, and the polymer (A′) is preferably contained in the range of 10 to 30 mass % with respect to the toner mother particles.

The toner particles according to the present invention preferably further contain a binder resin from the viewpoint of easily increasing the image strength of the toner image.

### <Binder Resin>

The binder resin is a resin that does not have an azobenzene group, and it is generally a resin that is used as a binder resin constituting a toner. Examples of the binder resin include a styrene resin, an acrylic resin, a styrene-acrylic resin, a polyester resin, a silicone resin, an olefin resin, an amide resin, and an epoxy resin. The binder resin may be used by 1 type and may be used in combination of 2 or more types.

In particular, the binder resin preferably contains an amorphous resin from the viewpoint of low viscosity when melted and high sharp melt properties. By including an amorphous resin, the glass transition temperature and viscosity of the toner can be adjusted to an appropriate range, which is preferable in terms of improving the fixing strength. The amorphous resin preferably includes at least one selected from the group consisting of a styrene resin, an acrylic resin, a styrene-acrylic resin, and a polyester resin. It is more preferable to include at least one selected from the group consisting of a styrene-acrylic resins and a polyester resin, and it is most preferable to include a styrene-acrylic resins.

### (Styrene-Acrylic Resin)

The styrene-acrylic resin is a polymer including at least a structural unit derived from a styrene monomer and a structural unit derived from a (meth)acrylate monomer.

Examples of the styrene monomer include those similar to the styrene monomer that constitutes the polymer (B1).

(Meth)acrylic acid in the (meth)acrylate monomer means acrylic acid and methacrylic acid. Examples of the (meth)acrylate monomer include: methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-Octyl (meth)acrylate, 2-ethylhexyl (meth)acrylate, stearyl (meth)acrylate, dodecyl (meth)acrylate, phenyl (meth)acrylate, diethylaminoethyl (meth)acrylate, and dimethylaminoethyl (meth)acrylate.

The styrene monomer and the (meth)acrylate monomer may be used singly or in combination of two or more.

The contents of the structural unit derived from the styrene monomer and the structural unit derived from the (meth)acrylate monomer in the styrene-acrylic resin are not particularly limited. They may be appropriately adjusted from the viewpoint of controlling the softening point and glass transition temperature of the binder resin. Specifically, the content of the structural unit derived from the styrene monomer is preferably in the range of 40 to 95 mass %, and more preferably in the range of 50 to 80 mass % with respect to the total amount of monomers. Further, the content of the structural unit derived from the (meth)acrylate monomer is preferably in the range of 5 to 60 mass %, and more preferably in the range of 10 to 50 mass % with respect to the total amount of the monomers.

The styrene-acrylic resin may further include a structural unit derived from a monomer other than the styrene monomer and the (meth)acrylate monomer as necessary. Examples of other monomers include vinyl monomers.

Examples of vinyl monomers include those shown below.
(1) Olefins: Ethylene, propylene, and isobutylene;
(2) Vinyl Esters: Vinyl propionate, vinyl acetate, and vinyl benzoate;
(3) Vinyl Ethers: Vinyl methyl ether, and vinyl ethyl ether;
(4) Vinyl Ketones: Vinyl methyl ketone, vinyl ethyl ketone, and vinyl hexyl ketone; and
(5) N-Vinyl Compounds: N-vinylcarbazole, N-vinylindole, and N-vinylpyrrolidon.
(6) Others: Vinyl compounds such as vinyl naphthalene and vinyl pyridine, acrylic acid or methacrylic acid derivatives such as acrylonitrile, methacrylonitrile and acrylamide.

### (Polyester Resin)

The polyester resin is a known polyester resin obtained by the polycondensation reaction of a divalent or higher valent carboxylic acid (polyvalent carboxylic acid component) and an alcohol having a divalent or higher valent (polyhydric alcohol component). The polyester resin may be amorphous or crystalline.

The number of valences of the polyvalent carboxylic acid component and the polyhydric alcohol component is preferably 2 to 3, and particularly preferably it is respectively 2. That is, the polyvalent carboxylic acid component preferably contains a dicarboxylic acid component, and the polyhydric alcohol component preferably contains a diol component.

Examples of the dicarboxylic acid component include: saturated aliphatic dicarboxylic acids such as oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid (dodecanedioic acid), 1,11-undecanedicarboxylic acid, 1,12-dodecanedicarboxylic acid, 1,13-tridecanedicarboxylic acid, 1,14-tetradecanedicarboxylic acid, 1,16-hexadecanedicarboxylic acid, and 1,18-octadecanedicarboxylic acid; unsaturated aliphatic dicarboxylic acids such as methylenesuccinic acid, fumaric acid, maleic acid, 3-hexendiodic acid, 3-octendioic acid, and dodecenyl succinic acid; and unsaturated aromatic dicarboxylic acids such as phthalic acid, terephthalic acid, isophthalic acid, t-butyl isophthalic acid, tetrachlorophthalic acid, chlorophthalic acid, nitrophthalic acid, p-phenylenediacetic acid, 2,6-naphthalenedicarboxylic acid, 4,4′-biphenyldicarboxylic acid, and anthracene dicarboxylic acid. In addition, lower alkyl esters and acid anhydrides of these compounds may also be used. The dicarboxylic acid components may be used alone or in combination of two or more. In addition, trivalent or higher polyvalent carboxylic acids such as trimellitic acid and pyromellitic acid, anhydrides of the above carboxylic acid compounds, and alkyl esters having 1 to 3 carbon atoms may also be used.

Examples of the diol component include: saturated aliphatic diols such as ethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,20-eicosandiol, and neopentyl glycol; unsaturated aliphatic diols such as 2-butene-1,4-diol, 3-butene-1,4-diol, 2-butyne-1,4-diol, 3-butyne-1,4-diol, and 9-octadecene-7,12-diol; aromatic diols such as bisphenols (bisphenol A and bisphenol F), and alkylene oxide adducts of these compounds (ethylene oxide adduct and propylene oxide adduct), and derivatives thereof The diol components may be used alone or in combination of two or more.

The content ratio of the compound (A) or the polymer (A′) to the binder resin is not particularly limited. For example, the ratio of the compound (A) or the polymer (A′): the binder resin is preferably 5:95 to 100:0 (mass ratio), more preferably 50:50 to 100:0 (mass ratio), and still more preferably, it is 60:40 to 1000 (mass ratio). When the toner particles include a binder resin, for example, the compound (A) or the polymer (A′): binder resin is preferably 50:50 to 95:5 (mass ratio). More preferably, it is 60:40 to 90:10 (mass ratio). When the content ratio is in the above range, the image strength and the adhesiveness can be further enhanced.

The glass transition temperature (Tg) of the toner particles is preferably 35 to 70° C., more preferably 40 to 60° C., from the viewpoints of fixability and heat-resistant storage stability. The glass transition temperature (Tg) of the toner particles mat be adjusted by the content ratio of the polymer and the binder resin, the kind of the binder resin, and the molecular weight.

The glass transition temperature of the toner can be measured by differential scanning calorimetry (DSC).

The toner particles may have a single layer structure or a core-shell structure. The type of the binder resin used for the core particle and the shell portion of the core-shell structure is not particularly limited.

The toner particles may further contain other components such as a colorant, a releasing agent, a charge controlling agent, and an external additive as necessary.

### <Colorant>

Dyes and pigments may be used as colorants.

Examples of a colorant to obtain a black toner are: carbon black, a magnetic material, and iron-titanium complex oxide black. Examples of carbon black that may be used include: channel black, furnace black, acetylene black, thermal black, and lamp black. Examples of a magnetic material that may be used include: ferrite and magnetite.

Examples of a colorant to obtain a yellow toner are: dyes such as C. I. Solvent Yellow 19, 44, 77, 79, 81, 82, 93, 98, 103, 104, 112, and 162; and pigments such as C. I. Pigment Yellows 14, 17, 74, 93, 94, 138, 155, 180, and 185.

Examples of a colorant to obtain a magenta toner are: dyes such as C. I. Solvent Red 1, 49, 52, 58, 63, 111, and 122; and pigments such as C. I. Pigment Red 5, 48: 1, 53: 1, 57: 1, 122, 139, 144, 149, 166, 177, 178, and 222.

Examples of a colorant to obtain a cyan toner are: dyes such as C. I. Solvent Blue 25, 36, 60, 70, 93, and 95; and pigments such as C. I. Pigment Blue 1, 7, 15, 60, 62, 66, and 76.

One kind of colorant or a combination of two or more kinds of colorants may be used to obtain each toner.

A content of the colorant in the toner with respect to the total mass of the toner is preferably in the range of 0.5 to 20 mass %, and more preferably in the range of 2 to 10 mass %.

### <Releasing Agent>

A usable releasing agent is not limited in particular. Various known waxes may be used. Examples of the wax are: low molecular weight polypropylene, polyethylene or oxidized low molecular weight polypropylene, polyolefin such as polyethylene, paraffin, and synthetic ester wax. It is particularly preferable to use a paraffin wax from the viewpoint of improving the storage stability of the toner.

A content ratio of the releasing agent is preferably in the range of 1 to 30 mass % in the toner particles, more preferably it is in the range of 3 to 15 mass %.

### <Charge Controlling Agent>

The used charge controlling agent is not limited in particular as long as it is a substance that is capable of providing positive or negative charge by a triboelectric charging, and colorless. Various known charge controlling agents that are positively chargeable or negatively chargeable may be used.

A content ratio of the charge controlling agent in the toner particles is preferably in the range of 0.01 to 30 mass %, and more preferably it is in the range of 0.1 to 10 mass % to the total mass of toner particles (100 mass %).

### <External Additive>

In order to improve fluidity, charging property, and cleaning property of the toner particles, an external additive such as fluidity increasing agent and cleaning assisting agent may be added to the toner particles as an after treatment agent.

Examples of the external additive are: inorganic oxide particles such as silica particles, alumina particles, and titanium oxide particles; inorganic stearic acid compound particles such as aluminum stearate particles and zinc stearate particles; and inorganic particles of inorganic titanium acid compound particles such as strontium titanate particles and zinc titanate particles. These may be used alone, or they may be used in combination of two or more kinds.

The inorganic particles may be subjected to a surface hydrophobization treatment with a silane coupling agent, a titanium coupling agent, a higher fatty acid, or silicone oil in order to improve heat-resistant storage stability and environmental stability.

An addition amount of the external additive in the toner particles is preferably in the rage of 0.05 to 5 mass % to the total mass of toner particles. More preferably, it is in the rage of 0.1 to 3 mass %.

### <Physical Properties of Toner Particles>

### (Average Particle Size)

It is preferable that the toner particles of the present invention have an average particle size of 4 to 20 μm, more preferably 5 to 15 μm in volume-based median diameter (D₅₀). When the volume-based median diameter (D₅₀) is within the above-described range, the transfer efficiency is improved, the image quality of halftone is improved, and the image quality such as fine lines and dots is improved.

The volume-based median diameter (D₅₀) of the toner particles may be measured and calculated by using measuring equipment composed of a “COULTER COUNTER 3” (Beckman Coulter Inc.) and a computer system installed with data processing software “Software V3.51” (Beckman Coulter Inc.) connected thereto.

In a specific measuring process, 0.02 g of sample to be measured (the toner particles) is blended in 20 mL of the surfactant solution (for the purpose of dispersing toner particles, for example, a surfactant solution in which a neutral detergent including a surfactant component is diluted by 10 times with pure water), ultrasonic dispersion is performed for 1 minute and a toner particle dispersion liquid is prepared. This toner particle dispersion liquid is poured into a beaker including ISOTON II (manufactured by Beckman Coulter, Inc.) in the sample stand with a pipette until the measurement concentration is 8 mass% By setting this content range, it is possible to obtain a reproducible measurement value. Then, the liquid is measured by setting the counter of the particle to be measured to 25,000. The aperture diameter is set to be 50 μm. The frequency count is calculated by dividing the range of the measurement range 1 to 30 μm by 256. The particle size where the accumulated volume counted from the largest size reaches 50% is determined as the volume-based median diameter (D₅₀).

### [Method for Producing Toner Particles]

The method for producing the toner particles is not particularly limited and any method may be used.

For example, when producing toner particles containing at least the compound (A) or the polymer (A′) and not containing a binder resin, after pulverizing the composition containing the compound (A) or the polymer (A′) using an apparatus such as a hammer mill, a feather mill, a counter jet mill, toner particles may be obtained by classification to a desired particle size using a dry classifier such as a spin air sieve, a crusher, or a micron classifier. The composition containing the compound (A) or the polymer (A′) is prepared by dissolving the compound (A) or the polymer (A′) and other components such as a colorant in a solvent as necessary. The composition may be obtained after removing the solvent.

Further, when producing toner particles containing the compound (A) or the polymer (A′) and a binder resin, it is preferable to obtain the toner particles by an emulsion aggregation method in which the particle size and shape can be easily controlled. Specifically, the production method for producing toner particles containing the compound (A) and the binder resin preferably contains the following steps.
(1A) Compound (A)-containing binder resin particle dispersion preparing step for obtaining a dispersion of compound (A)-containing binder resin particles;
(1B) Compound (A) particle dispersion preparing step for obtaining a dispersion of compound (A) particles;
(1C) Colorant particle dispersion preparation step for obtaining a dispersion of colorant particles;
(2) Adding a flocculant into the aqueous medium in which components such as the compound (A)-containing binder resin particles and, if necessary, colorant particles and further compound (A) particles are present, and an associating process in which coagulation and fusion are performed simultaneously with the progress of salting out to form associated particles;
(3) Aging step of forming toner particles by controlling the shape of the associated particles;
(4) Filtration and washing step for separating the toner particles from the aqueous medium and removing the surfactant from the toner particles;
(5) Drying step for drying the washed toner particles; and
(6) External additive addition step of adding an external additive to the dried toner particles.

When the toner particles further contain a colorant, it is preferable to perform (1C) a colorant particle dispersion preparation step to obtain a colorant particle dispersion before (2) the association step. Hereinafter, steps (1A) to (1C) will be described.

### (1A) Compound (A)-Containing Binder Resin Particle Dispersion Preparation Step

In this step, a binder resin dispersion containing the compound (A) can be obtained by a miniemulsion polymerization method using a vinyl monomer for obtaining a styrene-acrylic resin. For example, a vinyl monomer and a compound (A) are added to an aqueous medium, mechanical energy is applied to form droplets, and then polymerization is performed in the droplets by radicals from a water-soluble radical polymerization initiator. Then the reaction is allowed to proceed. An oil-soluble polymerization initiator may be contained in the droplet.

In addition, as a method for obtaining the compound (A)-containing binder resin particle dispersion, the following method may be used, for example. The compound (A) and the binder resin are dissolved in a solvent such as ethyl acetate to form a solution, and the solution is obtained using a disperser. Then, after emulsifying and dispersing in an aqueous medium, performing a solvent removal treatment.

If necessary, the binder resin containing the compound (A) may contain a releasing agent in advance. In addition, it is suitably polymerized in the presence of a known surfactant (for example, an anionic surfactant such as sodium polyoxyethylene (2) dodecyl ether sulfate, sodium dodecyl sulfate, or dodecylbenzene sulfonic acid) for facilitating dispersion.

The volume-based median diameter of the compound (A)-containing binder resin particles in the dispersion is preferably in the range of 50 to 300 nm. The volume-based median diameter of the compound (A)-containing binder resin particles in the dispersion can be measured by a dynamic light scattering method using “MICROTRAC UPA-150” (manufactured by Nikkiso Co., Ltd.).

### (1B) Compound (A) Particle Dispersion Preparation Step

In this step, the compound (A) is dispersed in the form of fine particles in an aqueous medium to obtain a dispersion of compound (A) particles.

Specifically, first, an emulsion of compound (A) is prepared. The emulsion of compound (A) may be obtained, for example, by dissolving compound (A) in an organic solvent and then emulsifying the obtained solution in an aqueous medium.

The method for dissolving the compound (A) in the organic solvent is not particularly limited, and for example, there is a method of adding the compound (A) to the organic solvent and stirring and mixing so that the compound (A) is dissolved. The amount of compound (A) added is preferably in the range of 5 to 100 mass parts, more preferably in the range of 10 to 50 mass parts, with respect to 100 mass parts of the organic solvent.

Next, the solution of the obtained compound (A) and the aqueous medium are mixed and stirred using a known disperser such as a homogenizer. Thereby, a compound (A) becomes a droplet and is emulsified in an aqueous medium, and the emulsion liquid of a compound (A) is obtained. The amount of the compound (A) solution added is preferably in the range of 10 to 90 mass parts, more preferably in the range of 30 to 70 mass parts with respect to 100 mass parts of the aqueous medium.

The temperature of the solution of the compound (A) and the temperature of the aqueous medium at the time of mixing the solution of the compound (A) and the aqueous medium are each lower than the boiling point of the organic solvent, preferably in the range of 20 to 80° C., more preferably in the range of 30 to 75° C.

As for the stirring conditions of the disperser, for example, when the volume of the stirring vessel is 1 to 3 L, the rotational speed is preferably in the range of 7,000 to 20,000 rpm, and the stirring time is preferably in the range of 10 to 30 minutes.

The compound (A) particle dispersion may be obtained by removing the organic solvent from the emulsion of compound (A). Examples of the method for removing the organic solvent from the emulsified liquid of the compound (A) include air blowing, heating, decompression, or a combination thereof. For example, the organic solvent may be removed by heating the emulsion of compound (A) in an inert gas atmosphere such as nitrogen, preferably in the range of 25 to 90° C., more preferably in the range of 30 to 80° C.

The mass average particle size of the particles in the compound (A) particle dispersion is preferably in the range of 90 to 1,200 nm. The mass average particle diameter can be measured using an electrophoretic light scattering photometer “ELS-800” (manufactured by Otsuka Electronics Co., Ltd.).

### <Organic Solvent>

The organic solvent is not particularly limited as long as it is possible to dissolve the compound (A). Examples of organic solvents include esters: such as ethyl acetate and butyl acetate; ethers such as diethyl ether, diisopropyl ether and tetrahydrofuran; ketones such as acetone and methyl ethyl ketone; saturated hydrocarbons such as hexane and heptane, halogenated hydrocarbons such as dichloromethane and dichloroethane and carbon tetrachloride. These organic solvents may be used alone or in combination of two or more. Of these, ketones and halogenated hydrocarbons are preferable, and methyl ethyl ketone and dichloromethane are more preferable.

### <Aqueous Medium>

The aqueous medium includes water or an aqueous medium containing water as a main component and water-soluble solvents such as alcohols and glycols, and optional components such as surfactants and dispersants. The aqueous medium may preferably be a mixture of water and a surfactant.

The surfactant may be a cationic surfactant, an anionic surfactant, or a nonionic surfactant. Examples of the cationic surfactant include dodecyl ammonium chloride, dodecyl ammonium bromide, dodecyl trimethyl ammonium bromide, dodecyl pyridinium chloride, dodecyl pyridinium bromide, and hexadecyl trimethyl ammonium bromide. Examples of the anionic surfactant include fatty acid soaps such as sodium stearate and sodium dodecanoate, sodium dodecylbenzenesulfonate, and sodium dodecylsulfate. Examples of the nonionic surfactant include polyoxyethylene dodecyl ether, polyoxyethylene hexadecyl ether, polyoxyethylene nonyl phenyl ether, polyoxyethylene dodecyl ether, polyoxyethylene sorbitan monooleate ether, and monodecanoyl sucrose. These surfactants may be used alone or in combination of two or more. Among them, preferably an anionic surfactant, more preferably sodium dodecylbenzenesulfonate is used.

The addition amount of the surfactant is preferably in the range of 0.01 to 1 mass part, more preferably in the range of 0.04 to 1 mass part with respect to 100 mass parts of the aqueous medium.

### (1C) Colorant Particle Dispersion Preparation Step

In this step, the colorant is dispersed in the form of fine particles in an aqueous medium to obtain a dispersion of colorant particles.

The colorant may be dispersed using mechanical energy. The number-based median diameter of the colorant particles in the dispersion is preferably in the range of 10 to 300 nm, and more preferably in the range of 50 to 200 nm. The number-based median diameter of the colorant particles may be measured using an electrophoretic light scattering photometer “ELS-800” (manufactured by Otsuka Electronics Co., Ltd.).

The steps from (2) the association step to (6) the external additive addition step may be performed according to various conventionally known methods.

In the association step (2), a flocculant is added to an aqueous medium containing the compound (A)-containing binder resin particle dispersion to advance salting out, and at the same time, aggregation and fusion are performed. By forming the associated particles, a part or all of the site derived from the compound (A) is included in a domain and exists as a domain It is preferable to add the compound (A) particle dispersion to the compound (A)-containing binder resin particle dispersion for increasing the area ratio of the domain Furthermore, in the aging step (3), it is preferable to perform stirring at a temperature of 30 ° C. or more and 70 ° C. or less for 1 hour or more after the shape control of the toner base particles is performed in that the domain formation may be promoted. In the association step (2), when the compound (A) particle dispersion and the binder resin particle dispersion are used instead of the compound (A)-containing binder resin particle dispersion, the compound (A) particles are more easily compatible with the binder resin. Further, in the aging step (3), when rapid cooling is done after controlling the shape of the toner base particles, the domain formation of the site derived from the compound (A) does not proceed, and the site derived from the compound (A) does not exist as a domain Here, rapid cooling refers to a cooling rate of 20° C./min or more.

In addition, the flocculant used in the association step (2) is not particularly limited, but those selected from metal salts are preferably used. Examples of metal salts include: monovalent metal salts such as alkali metal salts such as sodium, potassium and lithium; divalent metal salts such as calcium, magnesium, manganese and copper; and trivalent metal salts such as iron and aluminum. Specifically, examples of the metal salt include sodium chloride, potassium chloride, lithium chloride, calcium chloride, magnesium chloride, zinc chloride, copper sulfate, magnesium sulfate, and manganese sulfate. Among them, a divalent metal salt is particularly preferable because aggregation can be promoted with a smaller amount. These may be used alone or in combination of two or more.

In the case of producing toner particles containing the polymer (A′) and the binder resin, the producing method is as follows. A dispersion of the polymer (A′) particles is prepared, and the polymer (A′) particle dispersion and the binder resin particle dispersion are added to an aqueous medium with an aggregating agent, at the same time as salting-out proceeds, aggregation and fusion are performed to form associated particles. Thereby a part or all of the site derived from the compound (A) is contained in the domain and exists as a domain In the case of the polymer (A′), compared to the case of the compound (A), since the polymer (A′) is connected by a polymer chain, the portion of the compound (A) is not freely dispersed and it is assumed that it is easy to form a domain

### [Developer]

The developer may be a one-component developer including the above-described toner particles and a magnetic material, or may be a two-component developer including the above-described toner particles and carrier particles.

Examples of the magnetic material contained in the one-component developer include magnetite, γ-hematite, and various ferrites.

The carrier particles contained in the two-component developer include magnetic particles made of conventionally known materials such as metals such as iron, steel, nickel, cobalt, ferrite, and magnetite, and alloys of these metals with metals such as aluminum and lead.

The carrier particles may be coated carrier particles obtained by coating the surfaces of magnetic particles with a coating agent such as a resin, or may be resin-dispersed carrier particles in which magnetic powder is dispersed in a binder resin. Examples of the coating resin include an olefin resin, an acrylic resin, a styrene resin, styrene-acrylic resin, a silicone resin, a polyester resin, or a fluorine resin. Examples of the resin constituting the resin-dispersed carrier particles include an acrylic resin, a styrene-acrylic resin, a polyester resin, a fluororesin, and a phenol resin.

The volume-based median diameter of the carrier particles is preferably in the range of 20 to 100 gm, and more preferably in the range of 25 to 80 μm. The volume-based median diameter of the carrier particles may be typically measured by a laser diffraction particle size distribution measuring apparatus “HELOS” (manufactured by SYMPATEC Co., Ltd.) equipped with a wet disperser.

The content of the toner particles in the developer is preferably in the range of 2 to 10 mass % with respect to 100 mass % of the total mass of toner particles and carrier particles.

### [Image Forming Method]

The toner of the present invention may be used in an electrophotographic image forming method, for example, in a monochrome image forming method or in a full color image forming method. In the full-color image forming method, the present invention may be applied to any image forming method such as a four-cycle type image forming method including four types of color developing devices for each of yellow, magenta, cyan, and black, and one photoconductor; and a tandem image forming method in which an image forming unit having a color developing device and a photoconductor for each color is mounted for each color.

The image forming method of the present invention includes the steps of (1) forming a toner image with the toner of the present invention on a recording medium, and (2) irradiating the formed toner image with light to soften the toner image, thereby fixing the toner image on the recording medium.

### About the Step (1)

In this step, a toner image made of the toner of the present invention is formed on a recording medium.

### (Recoding Media)

The recording medium is a member for holding a toner image. Examples of the recording medium include coated printing paper such as plain paper, high-quality paper, art paper, and coated paper, commercially available Japanese paper and postcard paper, resin films for OHP or packaging materials, and cloth.

The recording medium may be a sheet (sheet-like) having a predetermined size, or may be a long shape wound up in a roll after the toner image is fixed.

As will be described later, the toner image may be formed, for example, by transferring the toner image on the photoreceptor onto a recording medium.

### About the Step (2)

In this step, the formed toner image is irradiated with light to fix the toner image on the recording medium. Specifically, the toner image is adhered to the recording medium by irradiating the toner image with light to soften the toner image.

The wavelength of the light to be irradiated may be such that the compound (A) or the polymer (A′) in the toner particles may sufficiently soften the toner image by absorbing light and undergoing phase transition. It is preferably in the range of 280 to 480 nm. Further, from the same viewpoint, the amount of light irradiation is preferably 0.1 to 200 J/cm², more preferably 0.5 to 100 J/cm², and still more preferably 1.0 to 50 J/cm².

As described later, the light irradiation can be performed using a light source such as a light emitting diode (LED) or a laser light source.

After the step (2), a pressurizing step for pressurizing the softened toner image may be further performed as necessary.

The pressure at the time of pressurizing the toner image is not particularly limited, but the pressure given to the toner image transferred onto the recording medium is preferably in the range of 0.01 to 1.0 MPa, and more preferably it is in the range of 0.05 to 0.5 MPa. By setting the pressure to 0.01 MPa or more, the deformation amount of the toner image can be increased, so that the contact area between the toner image and the recording paper S increases, and the image strength may be further increased. Moreover, it can suppress that the glossiness of the image obtained becomes high too much by making a pressure into 1.0 Mpa or less.

The pressurizing step may be performed before or simultaneously with the step of irradiating light and softening the toner image (the step (2) described above). However, it is preferable to perform the pressurizing step after the light irradiation because it is possible to pressurize the toner image in a softened state in advance, and as a result, the image strength is further improved.

As described above, in the toner of the present invention, the toner particles contain the compound (A) or the polymer (A′), and a part or all of the site derived from the compound or the polymer exists as a domain in the toner particles. Accordingly, the range of decrease in melt viscosity is increased, and in the step (2), the toner image is well melted or softened by light irradiation and fixed on the recording medium, and the image strength of the obtained toner image may be increased.

The image forming method of the present invention may be performed, for example, by using the following image forming apparatus.

### <Image Forming Apparatus>

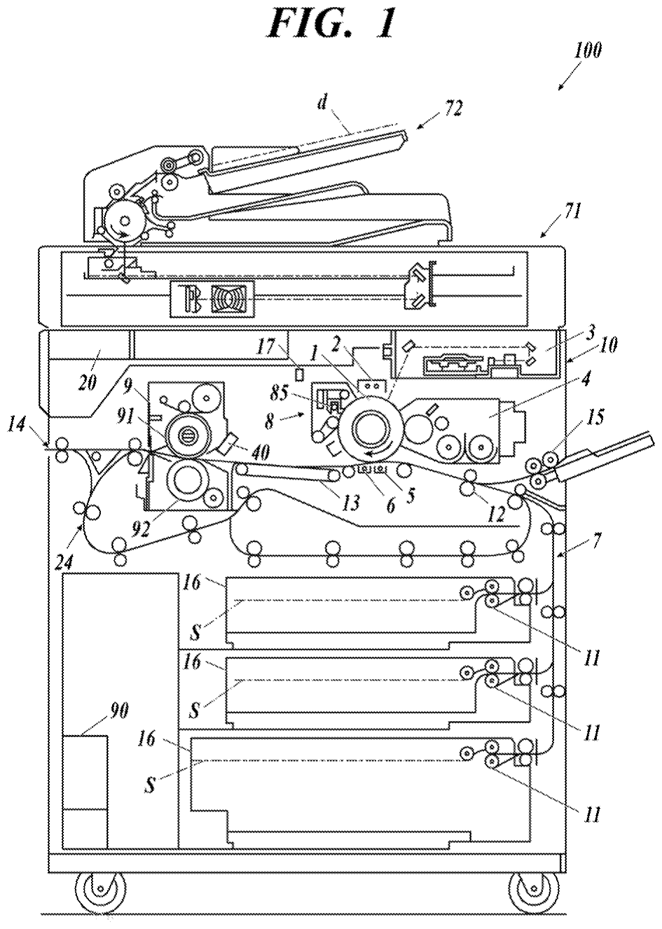

FIG. 1 is a schematic configuration diagram illustrating an image forming apparatus 100. FIG. 1 indicates an example of a monochrome image forming apparatus 100, but the present invention may also be applied to a color image forming apparatus. Further, although an example in which a recording paper S is used as a recording medium will be described, the present invention is not limited to this.

The image forming apparatus 100 includes an automatic document feeder 72, an image reading device 71, a paper transport system 7, an image forming unit 10, an irradiation unit 40, and a pressure bonding unit 9.

The automatic document feeder 72 includes a document table and a conveyance mechanism that conveys the document d set on the document table, and conveys the document d to the image reading device 71.

The image reading device 71 includes a scanning exposure device, an image sensor CCD, and an image processing unit 20. Then, the document d placed on the document table of the automatic document feeder 72 is conveyed to the image reading device 71, scanned and exposed by an optical system of the scanning exposure device, and read into the image sensor CCD. The analog signal photoelectrically converted by the image sensor CCD is subjected to analog processing, A/D conversion, shading correction, and image compression processing in the image processing unit 20 and then input to the exposure device 3 of the image forming unit 10.

The paper transport system 7 includes a plurality of trays 16, a plurality of paper feeding units 11, a transport roller 12, and a transport belt 13. The tray 16 accommodates recording paper S of a predetermined size, and operates the paper supply unit 11 of the tray 16 determined according to an instruction from the control unit 90 to supply the recording paper S. The conveyance roller 12 conveys the recording paper S sent out from the tray 16 by the paper feeding unit 11 or the recording paper S carried in from the manual paper feeding unit 15 to the image forming unit 10.

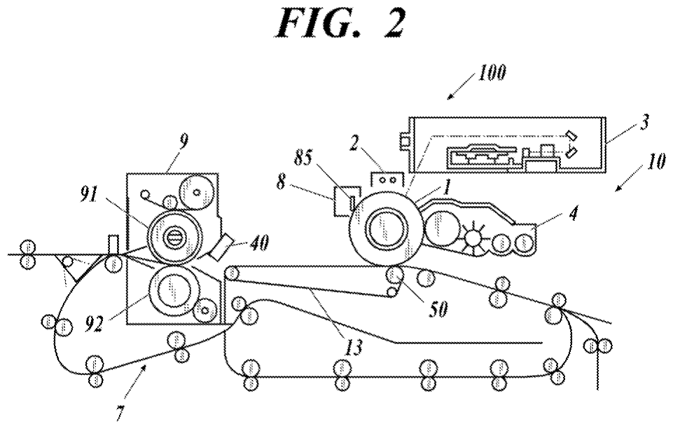

FIG. 2 is a partially enlarged view illustrating a peripheral configuration of the image forming unit 10, the irradiation unit 40, and the pressure bonding unit 9 in FIG. 1.

In the image forming unit 10, a charger 2, an exposure unit 3, a developing unit 4, a transfer unit 5, a charge eliminating unit 6, and a cleaning unit 8 are arranged in this order around the photoreceptor 1 along the rotation direction of the photoreceptor 1.

The photoreceptor 1 is an image carrier having a photoconductive layer formed on the surface thereof, and is configured to be rotatable in the direction of the arrow in FIG. 1 by a driving device (not shown). A thermohygrometer 17 that detects the temperature and humidity in the image forming apparatus 100 is provided in the vicinity of the photoreceptor 1.

The charger 2 uniformly charges the surface of the photoreceptor 1 and charges the surface of the photoreceptor 1 uniformly.

The exposure device 3 includes a beam emission source such as a laser diode. The exposure unit 3 irradiates the charged surface of the photoreceptor 1 with the beam light, thereby erasing the charge of the irradiated portion. An electrostatic latent image is formed.

The developing unit 4 supplies toner contained therein to the photoreceptor 1 to form a toner image based on the electrostatic latent image on the surface of the photoreceptor 1.

The transfer unit 5 is disposed to face the photoreceptor 1 with the recording paper S interposed therebetween, and transfers the toner image to the recording paper S.

The charge eliminating unit 6 performs neutralization on the photoreceptor 1 after the toner image is transferred.

The cleaning unit 8 includes a blade 85. The surface of the photoreceptor 1 is cleaned by the blade 85 to remove the developer remaining on the surface of the photoreceptor 1.

The irradiation unit 40 is a light source that irradiates light onto the toner image formed on the recording paper S. Specifically, the irradiation unit 40 is disposed on the photoreceptor 1 side with respect to the recording paper S surface nipped between the photoreceptor 1 and the transfer roller 50. The irradiation unit 40 is disposed between the nip position (formed by the photoreceptor 1 and the transfer roller 50) and the pressure bonding unit 9 in the paper transport direction.

Examples of the irradiation unit 40 include a light emitting diode (LED) and a laser light source. Thereby, the toner image containing the polymer (A) is melted or softened, and the toner image is fixed on the recording paper S. The wavelength of light to be irradiated and the irradiation amount are as described above.

The pressure bonding unit 9 is arbitrarily installed, and a fixing process is performed on the recording paper S on which the toner image is transferred by applying pressure alone or heat and pressure by the pressure members 91 and 92, thereby the image is fixed on the paper S. The recording sheet S on which the image is fixed is transported to the paper discharge unit 14 by the transport roller, and is discharged from the paper discharge unit 14 to the outside of the apparatus.

Further, the image forming apparatus 100 includes a paper reversing unit 24. As a result, the recording sheet S that has been heat-fixed is conveyed to the sheet reversing unit 24 in front of the paper discharge unit 14, and is discharged with the front and back reversed, or the recording sheet S with the front and back reversed is again formed in the image forming unit 10, and image formation can be performed on both sides of the recording paper S.

An image forming method using the image forming apparatus illustrating in FIG. 1 will be described below.

First, the charger 2 is charged by applying a uniform potential to the photoreceptor 1 and then scanned on the photoreceptor 1 with a light beam irradiated by the exposure device 3 based on the original image data, thereby forming an electrostatic latent image. Next, a developer containing a compound (the compound (A) or polymer (A′)) that undergoes phase transition by light absorption is supplied onto the photoreceptor 1 by the developing unit 4.

When the recording sheet S is conveyed from the tray 16 to the image forming unit 10 in accordance with the timing at which the toner image carried on the surface of the photoreceptor 1 reaches the position of the transfer roller 50 by the rotation of the photoreceptor 1, the toner image on the photoreceptor 1 is transferred onto the recording sheet S nipped between the transfer member 50 and the photoreceptor 1 by the applied transfer bias.

The transfer roller 50 also serves as a pressure member, and securely transfers the toner image to the recording paper S while transferring the toner image from the photoreceptor 1 to the recording paper S.

After the toner image is transferred to the recording paper S, the blade 85 of the cleaning unit 8 removes the developer remaining on the surface of the photoreceptor 1.

In this way, the recording paper S to which the toner image has been transferred is conveyed to the irradiation unit 40 and the pressure bonding unit 9 by the conveyance belt 13.

The irradiation unit 40 irradiates the toner image transferred onto the recording paper S with light (preferably light in the range of 280 to 480 nm). Since the toner image is melted and softened by irradiating the toner image on the recording paper S with the irradiation unit 40, the toner image is fixed to the recording paper S.

When the recording paper S on which the toner image is held reaches the pressure bonding unit 9 by the conveying belt 13, the recording paper S on which the toner image is formed is pressure-bonded by the pressure member 91 and the pressure member 92. Since the toner image is softened by light irradiation by the irradiation unit 40 before being pressed by the pressure bonding unit 9, the toner image on the recording paper S can be pressed with lower energy.

The pressure at the time of pressurizing the toner image is as described above. The pressurizing step may be performed before or simultaneously with or after the step of softening the toner image by irradiating light. From the viewpoint of being able to pressurize the toner image that has been softened in advance and easily increasing the image intensity, the pressurizing step is preferably performed after light irradiation.

The pressure member 91 can heat the toner image on the recording paper S when the recording paper S passes between the pressure member 91 and the pressure member 92. The toner image softened by the light irradiation is further softened by this heating, and as a result, the fixability (image strength) of the toner image to the recording paper S is further improved.

The heating temperature of the toner image is as described above. The heating temperature of the toner image (the surface temperature of the toner image) can be measured with a non-contact temperature sensor. Specifically, for example, a non-contact temperature sensor may be installed at a position where the recording medium is discharged from the pressure member, and the surface temperature of the toner image on the recording medium may be measured.

The toner images pressed by the pressure member 91 and the pressure member 92 are solidified and fixed on the recording paper S.

### EXAMPLES

Hereinafter, the present invention will be specifically described with reference to examples, but the present invention is not limited thereto. Unless otherwise specified, “%” and “part” mean “mass %” and “mass part”, respectively.

### [Synthesis of Compound (A) and Polymer (A′)]

The compound (A) and the polymer (A′) synthesized below are as follows. The number average molecular weight of the polymer (A′) indicated below is 9,600.

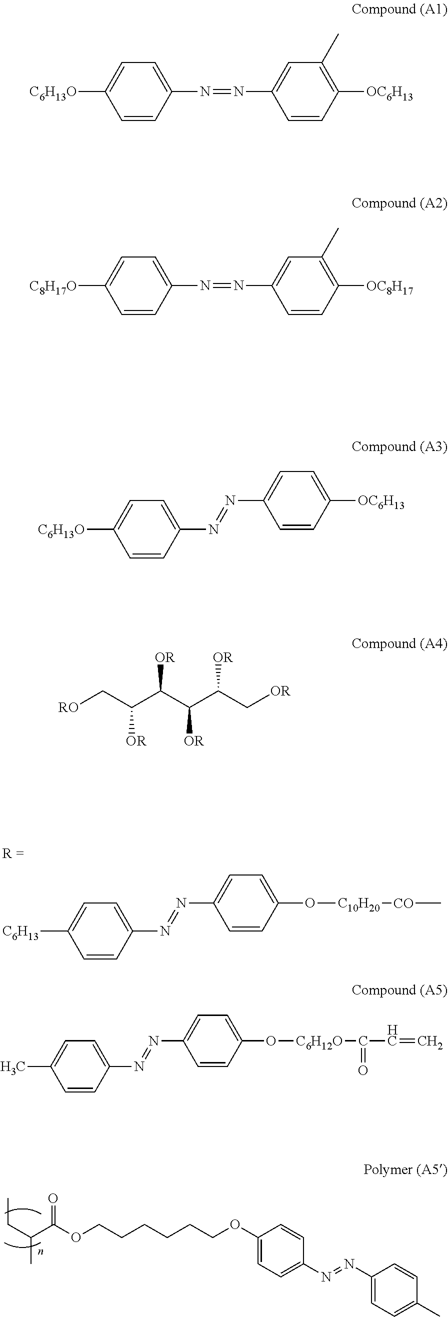

### Synthesis Example 1: Synthesis of Compound (A1)

After adding 75 mL of 2.4N hydrochloric acid to 4-aminophenol (6.54 g, 60 mmol), a solution of sodium nitrite (4.98 g, 72 mmol) dissolved in 6 mL of distilled water was added with cooling and stirring at 0° C. Stirring was continued at 0° C. for 60 minutes. To this solution, a mixed solution of o-cresol (6.48 g, 60 mmol) and 20 mL of 20% aqueous sodium hydroxide was added and stirred for 20 hours. The deposited precipitate was filtered, and the solid was washed with water. The obtained solid was purified by silica gel column chromatography using a mixed solution of ethyl acetate and hexane as a developing solvent, and recrystallized with a mixed solvent of acetone and hexane to obtain an intermediate A (First step).

To this intermediate A (2.28 g, 10 mmol), DMF (100 mL), 1-bromohexane (9.9 g, 60 mmol) and potassium carbonate (6.9 g, 50 mmol) were added, stirred at 80° C. for 2 hours, and then stirring was continued at room temperature for 20 hours. The solvent was distilled off under reduced pressure, followed by extraction with ethyl acetate, and the organic layer was washed with saturated brine and then dried over anhydrous magnesium sulfate. After filtering this, the solvent was distilled off under reduced pressure, and the resulting solid was purified by silica gel column chromatography using a mixture of ethyl acetate and hexane as a developing solvent, whereby the compound (A1) which was an azobenzene derivative was obtained (Second step).

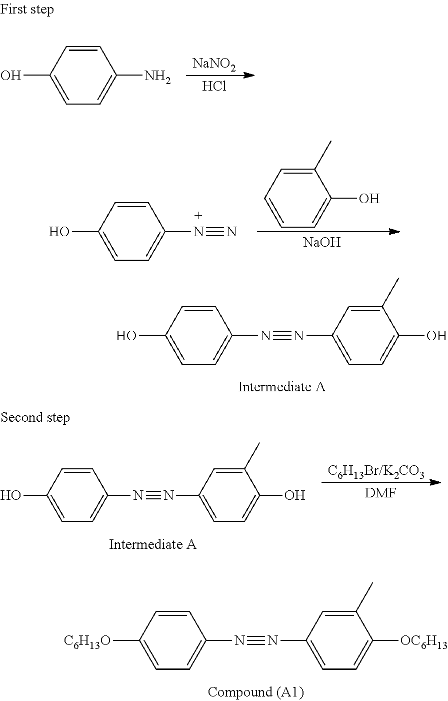

### Synthesis Example 2: Synthesis of Compound (A2)

Compound (A2) was obtained in the same manner as in Synthesis Example 1 except that C₆H13Br in the reaction scheme was changed to C₈H₁₃Br.

### Synthesis Example 3: Synthesis of Compound (A3)

To 4,4′-dihydroxyazobenzene (0.21 g, 1.0 mmol) were added 10 mL of DMF, 1-bromohexane (0.99 g, 6.0 mmol), and potassium carbonate (0.69 g, 5.0 mmol). After stirring the mixture at 80° C. for 2 hours, stirring was continued at room temperature for 12 hours. The solvent was distilled off under reduced pressure, followed by extracted with ethyl acetate, and the organic layer was washed with saturated brine and then dried over anhydrous magnesium sulfate. After filtration, the solvent was distilled off under reduced pressure, and the resulting solid was purified by silica gel column chromatography using a mixed solution of ethyl acetate and hexane as a developing solvent. Then, the compound (A3) which is an azobenzene derivative was obtained by removing a solvent.

### Synthesis Example 4: Synthesis of Compound (A4)

105 parts of 4-hexyl-4′-hydroxyazobenzene, 99 parts of 11-bromoundecanoic acid, and 46 parts of potassium hydroxide were dissolved in 2923 parts of ethanol to obtain a raw material solution. Next, the raw material solution was stirred at 100° C. for 3 days, and then neutralized with hydrochloric acid and acetic acid. As a result, precipitates were deposited in the raw material solution. And the precipitate in the raw material solution was filtered and then washed with water. Next, the obtained precipitate was separated by column chromatography using a mixed solvent of chloroform and ethyl acetate as a developing solvent to obtain 90 mass parts of 11-[4-(4-hexylphenylazo)phenoxy]undecanoic acid. Next, 88 mass parts of 11-[4-(4-hexylphenylazo)phenoxy]undecanoic acid were dissolved in 398 parts of dehydrated dichloromethane to obtain an intermediate solution. Then, after adding 164 mass parts of thionyl chloride to the intermediate solution, the intermediate solution was heated to reflux for 1 hour. Then, after distilling off dichloromethane and thionyl chloride from the refluxed intermediate solution, 663 mass parts of dehydrated dichloromethane were added. Next, the intermediate solution to which dichloromethane was added was slowly added to a mannitol suspension in which 5 mass parts of D-mannitol was suspended in 295 mass parts of dehydrated pyridine, and then stirred at room temperature for 4 days. Subsequently, the obtained reaction solution was purified by column chromatography using a mixed solvent of dichloromethane, hexane and ethyl acetate as a developing solvent in the dark to obtain a compound (A4) represented by the following chemical formula.

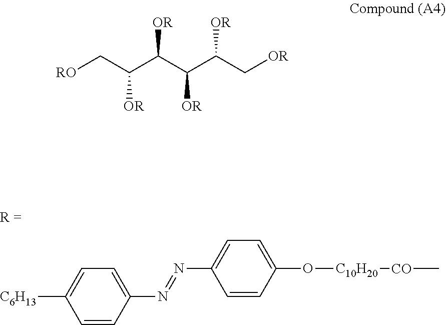

### Synthesis Example 5: Synthesis of Compound (A5)

### (Synthesis of Azobenzene Derivative Monomer)

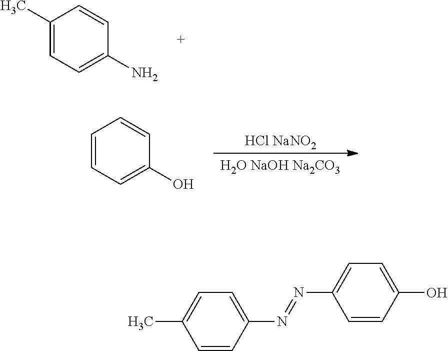

Ina 300 ml three-necked flask, 6.44 g (0.933 mol) of sodium nitrite was dissolved in 20 ml of water and cooled until the inner temperature reached 0° C. To this, 5 g (0.047 mol) of p-toluidine and 23 g of 0.2N hydrochloric acid aqueous solution were slowly added dropwise at an inner temperature of 5° C. or lower. After dropping, the mixture was stirred for 30 minutes while maintaining the inner temperature. To the resulting solution, a solution obtained by dissolving 5.71 g (0.06 mol) of phenol, 2.43 g (0.06 mol) of sodium hydroxide and 6.43 g (0.06 mol) of sodium carbonate in 20 ml of water was slowly added dropwise to precipitate yellow crystals, while keeping the inner temperature at 5° C. or lower. After completion of the dropwise addition, the mixture was stirred for 30 minutes while maintaining the internal temperature, filtered and washed with cold water to obtain orange crystals. This was dried and then purified by a silica gel column (ethyl acetate/heptane=¼) to obtain 9.7 g (yield 97.9%) of the desired product (4-(p-toluyldiazenyl)phenol).

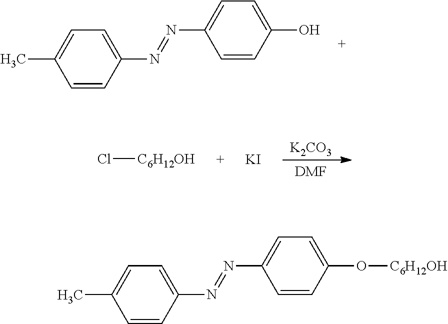

In a 200 ml four-necked flask, 5 g (0.024 mol) of the obtained target product (4-(p-toluyldiazenyl)phenol) was dissolved in 25 ml of dimethylformamide (DMF). To this was added 4.88 g (0.035 mol) of potassium carbonate, and the mixture was stirred for 30 minutes while maintaining at 30° C. To this, 10.2 mg (0.06 mmol) of potassium iodide and 3.54 g (0.026 mol) of 6-chloro-1-hexanol were added and reacted at 110° C. for 3 hours. This was cooled to room temperature, and added 650 g of ice and filtered. The crystals were dispersed in 400 ml of water, washed with stirring overnight, filtered and dried. Recrystallization from ethanol gave 6.41 g (yield: 87.1%) of orange crystals (target product 2(6-(4-(p-toluylazenyflphenoxy)hexane-1-01)).

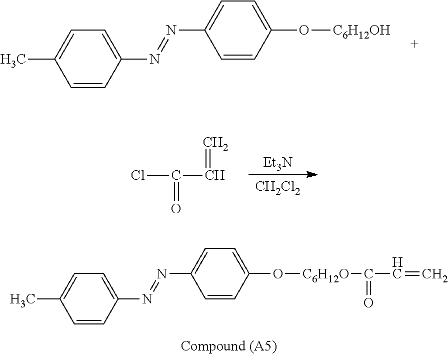

In a 100 ml four-necked flask, 3 g (0.001 mol) of the obtained target product 2 (6-(4-(p-toluylazenyflphenoxy)hexane-1-ol), 1.34 ml (0.001 mol) triethylamine and 30 ml dichloromethane were added. At this time, the raw material was in a dispersed state. While maintaining the inner temperature at 0 to 5° C., a solution of 1.04 g (0.011 mol) of acrylic acid chloride dissolved in 10 ml of dichloromethane was added dropwise.

As it was dropped, the raw material dissolved. After completion of dropping, the reaction solution was returned to room temperature and stirred for 5 hours. After completion of the reaction, dichloromethane was concentrated and removed, the reside was dissolved in ethyl acetate, washed with dilute hydrochloric acid, aqueous sodium hydrogen carbonate solution and saturated brine, and the organic layer was dried over magnesium sulfate and concentrated. The resulting orange crystals were purified with a silica gel column (ethyl acetate/heptane=⅕) to obtain 2.87 g (51.4%) of compound A5: azobenzene derivative monomer 1.

### <Synthesis of Polymer (A5′)>

In a 100 ml four-necked flask, 1.5 g (4.096 mmol) of the obtained azobenzene derivative monomer 1, 5 mg (0.023 mmol) of 4-cyanopentanoic acid dithiobenzoate, and 1 mg (0.006 mmol) of AIBN were dissolved in 4 ml of anisole. And after making the mixture in an argon gas atmosphere by freeze deaeration, the mixture was heated up at 75° C., and polymerized by stirring for 48 hours. After 40 ml of methanol was gradually added dropwise to the polymer solution, THF was added to remove unreacted azobenzene derivative monomer 1. The separated polymer solution was dried in a vacuum drying furnace at 40° C. for 24 hours to obtain a polymer (A5′) containing the structural unit of compound (A5).

### <Preparation of Toner Particles 1>

(Preparation of Compound (A1)-containing styrene-acrylic resin particle dispersion (S1))

### (1) First Stage Polymerization

Into a 1 L reaction vessel equipped with a stirrer, a temperature sensor, a cooling tube and a nitrogen introducing device, 1.0 mass part of sodium polyoxyethylene-2-dodecyl ether sulfate and 750 mass parts of ion-exchanged water were charged. The inner temperature was raised to 80° C. while stirring at a stirring speed of 150 rpm under a nitrogen stream. After the temperature increase, 2.5 mass parts of potassium persulfate (KPS) dissolved in 50 mass parts of ion-exchanged water was added, and the liquid temperature was made to 75° C. Thereafter, a monomer mixed solution consisting of 142 mass parts of styrene (St), 41 mass parts of n-butyl acrylate (BA) and 17 mass parts of methacrylic acid (MAA) was added dropwise over 1 hour. After completion of the dropping, polymerization (first stage polymerization) was performed by heating and stirring at 80° C. for 2 hours to prepare a dispersion of resin particles (s1).

### (2) Second Stage Polymerization

Into a 5 L reaction vessel equipped with a stirrer, a temperature sensor, a cooling tube and a nitrogen introducing device, a solution obtained by dissolving 0.5 mass parts of polyoxyethylene-2-dodecyl ether sulfate in 750 mass part of ion-exchanged water was charged. This was heating to 80° C. Then, a monomer mixed solution containing 10.5 mass parts (in terms of solid content) of a dispersion of resin particles (s1), 48.8 mass parts of styrene (St), 22.8 mass parts of n-butyl acrylate (BA), 5.0 mass parts of methacrylic acid (MAA), 1.0 mass part of n-octyl mercaptan, and 11.6 g of compound (A1) dissolved at 80° C. was added. The reaction system was mixed and dispersed for 30 minutes by using a mechanical disperser with a circulation route “CLEARMIX” (manufactured by M Technique Co. Ltd.) so that a dispersion liquid containing emulsion particles (oil particles) was prepared. Next, an initiator solution in which 10 mass part of potassium persulfate (KPS) was dissolved in 25 mass parts of ion-exchanged water was added to this dispersion, and the system was heated and stirred at 80° C. for 1 hour. The polymerization (second stage polymerization) was carried out. Thus, a dispersion of resin particles (s1′) was prepared.

### (3) Third Stage Polymerization

An initiator solution prepared by dissolving 2.0 mass parts of potassium persulfate (KPS) in 38 mass parts of ion-exchanged water was added to the dispersion of resin particles (s1′). Under the temperature condition of 80° C., a monomer mixed solution containing 85.0 mass parts of styrene (St), 30.0 mass parts of n-butyl acrylate (BA), 8.0 mass parts of methacrylic acid (MAA) and 2.0 mass parts of n-octyl mercaptan was added dropwise over 1 hour. After completion of the dropping, polymerization (third stage polymerization) was performed by heating and stirring for 2 hours. Then, by cooling to 28° C., a styrene-acryl resin particle dispersion (S1) was prepared. This dispersion contained fine particles of styrene-acrylic resin containing compound (A1) and dispersed in an aqueous medium. The fine particles had a volume-based median diameter (D₅₀) of 168 nm.

### <Preparation of Compound (A2)-Containing Styrene-Acrylic Resin Particle Dispersion (S2) and Compound (A3)-Containing Styrene-Acrylic Resin Particle Dispersion (S3)>

A compound (A2)-containing styrene-acrylic resin particle dispersion (S2) and a compound (A3)-containing styrene-acrylic resin particle dispersion (S3) were prepared in the same manner as in the preparation of the compound (A1)-containing styrene-acrylic resin particle dispersion (S1), except that the compound (A1) is changed to the compounds (A2) and (A3), respectively.

### <Preparation of Styrene-Acrylic Resin Particle Dispersion (S4)>

Into a 1 L reaction vessel equipped with a stirrer, a temperature sensor, a cooling tube and a nitrogen introducing device, 1.0 mass part of sodium lauryl sulfate and 500 mass parts of ion-exchanged water were charged, and while stirring at a stirring speed of 230 rpm under a nitrogen stream, the inner temperature was raised to 80° C. Subsequently, a solution in which 3.0 mass parts of potassium persulfate (KPS) was dissolved in 71 mass parts of ion-exchanged water was added, and the liquid temperature was set to 80° C. Further, a monomer mixed solution containing 180.0 mass parts of styrene (St), 56.4 mass parts of n-butyl acrylate (BA), 2.4 mass parts of acrylic acid (AA), and 16 mass parts of n-octyl mercaptan was added dropwise over 2 hours. After completion of dropping, the mixture was polymerized by heating and stirring at 80° C. for 2 hours to obtain a styrene-acrylic resin dispersion (S4). The volume-based median diameter (D₅₀) of this dispersion was measured with MICROTRAC UPA-150 (manufactured by Nikkiso Co., Ltd.) and found to be 130 nm.

### <Preparation of Colorant Particle Dispersion (Bk1)>

11.5 mass parts of sodium lauryl sulfate was dissolved in 1600 mass parts of pure water, and 25 mass parts of carbon black “MOGUL L” (manufactured by Cabot) was gradually added. Next, a colorant particle dispersion (Bk1) was prepared using “CLEARMIX (registered trademark) W motion CLM-0.8” (manufactured by M Technique Co., Ltd.). The volume-based median diameter (D50) of the colorant particles in this dispersion was measured using MICROTRAC UPA-150 (manufactured by Nikkiso Co., Ltd.) and found to be 110 nm.

### <Preparation of Compound (A1) Particle Dispersion>

80 mass parts of dichloromethane and 20 mass part of compound (A1) were mixed and stirred while heating at 50° C. to obtain a liquid containing compound (A1). A mixed solution of 99.5 mass parts of distilled water warmed to 50° C. and 0.5 mass parts of a 20 mass % aqueous sodium dodecylbenzenesulfonate solution was added to 100 mass parts of this liquid. Thereafter, the mixture was stirred and emulsified at 16000 rpm for 60 minutes with a homogenizer (manufactured by Heidorf Co. Ltd.) equipped with a shaft generator 18F to obtain an emulsion of compound (A1). The obtained emulsified liquid of compound (A1) was placed into a separable flask, and the organic solvent was removed by heating and stirring at 40° C. for 90 minutes while supplying nitrogen into the gas phase. Thereby a compound (A1) particle dispersion was obtained. The solid content of the compound (A1) particle dispersion was 10.0 mass % The volume-based median diameter of the compound (A1) particles in the dispersion was 142 nm as measured using MICROTRAC UPA-150 (manufactured by Nikkiso Co., Ltd.).

### <Preparation of Compound (A2) to (A4) Particle Dispersion>

Compound (A2) to (A4) particle dispersions were obtained in the same manner as in the preparation of the compound (A1) particle dispersion, except that compound (A1) was changed to compounds (A2) to (A4), respectively.

### <Preparation of Polymer (A5′) Particle Dispersion>

A polymer (A5′) particle dispersion was obtained in the same manner as in the preparation of the compound (A1) particle dispersion, except that the compound (A1) was changed to the polymer (A5′).

### [Preparation of Toner Particles]

### <Preparation of Toner Particles 1>

In a reaction vessel equipped with a stirrer, a temperature sensor, and a cooling tube, 100 mass parts (converted to solid content) of compound (A1)-containing styrene-acrylic resin particle dispersion (S1) and 400 mass parts of ion-exchanged water were charged. Then, 5 mol/L sodium hydroxide aqueous solution was added under stirring at 150 rpm, and pH (25° C. conversion) was adjusted to 10. Thereafter, 5 mass parts (in terms of solid content) of the colorant particle dispersion (Bk1) was added, and then an aqueous solution in which 15 mass parts of magnesium chloride was dissolved in 15 mass parts of ion-exchanged water was stirred at 150 rpm at 30° C. and added over 10 minutes. After leaving this system for 3 minutes, the temperature was raised to 70° C. over 60 minutes with stirring at 200 rpm, and the particle growth reaction was continued while maintaining 70° C. In this state, the particle size of the associated particles was measured with “COULTER MULTISIZER 3” (manufactured by Coulter Beckman), and when the volume-based median diameter (D50) became 6.5 μm, particle growth was stopped by adding an aqueous solution in which 20 mass parts of sodium chloride was dissolved in 80 mass parts of ion-exchanged water. After maintaining in this state for 2 hours, the temperature was lowered to 50° C. over 30 minutes, and the mixture was further stirred for 1 hour at 300 rpm, thereby forming a domain of the compound (Al). Then, the system was cooled to 30° C. over 60 minutes. Next, the operation of solid-liquid separation, re-dispersing the dehydrated toner cake in ion-exchanged water and solid-liquid separation was repeated three times, and then dried at 40° C. for 24 hours to obtain toner mother particles. 1 mass % of hydrophobic silica (number average primary particle size: 12 nm) and 0.3 mass % of hydrophobic titania (number average primary particle size: 20 nm) were added to the obtained toner mother particles. Toner particles 1 were obtained by adding 1 mass % of hydrophobic silica (number average primary particle size: 12 nm) and 0.3 mass % of hydrophobic titania (number average primary particle size: 20 nm) and mixing using a Henschel Mixer (registered trademark).

### <Preparation of Toner Particles 2>

The particle growth was stopped in the same manner as in the preparation of toner particles 1. After maintaining in this state for 2 hours, the temperature was lowered to 50° C. over 30 minutes, and the mixture was further stirred for 2 hours at 300 rpm to form a domain of the compound (A1). Then, the system was cooled to 30° C. over 60 minutes.

### <Preparation of Toner Particles 3>

In a reaction vessel equipped with a stirrer, a temperature sensor, and a cooling tube, 72.3 mass parts (converted to solid content) of compound (A1)-containing styrene-acrylic resin particle dispersion (S1) and 400 mass parts of ion-exchanged water were charged. Then, 5 mol/L sodium hydroxide aqueous solution was added under stirring at 150 rpm, and pH (25° C. conversion) was adjusted to 10. Thereafter, 5 mass parts (in terms of solid content) of the colorant particle dispersion (Bk1) was added, and then an aqueous solution in which 15 mass parts of magnesium chloride was dissolved in 15 mass parts of ion-exchanged water was stirred at 150 rpm at 30° C. and added over 10 minutes. After leaving this system for 3 minutes, the temperature was raised to 70° C. over 60 minutes with stirring at 200 rpm. Thereafter, while maintaining 70° C., 27.7 mass parts of the compound (A1) particle dispersion (solid content conversion) were added over 30 minutes. A particle growth reaction was continued while maintaining 70° C. In this state, the particle size of the associated particles was measured with “COULTER MULTISIZER 3” (manufactured by Coulter Beckman), and when the volume-based median diameter (D50) became 6.5 μm, particle growth was stopped by adding an aqueous solution in which 20 mass parts of sodium chloride was dissolved in 80 mass parts of ion-exchanged water. After maintaining in this state for 2 hours, the temperature was lowered to 50° C. over 30 minutes, and the mixture was further stirred for 1 hour at 300 rpm, thereby forming a domain of the compound (A1). Then, the system was cooled to 30° C. over 60 minutes. Next, the operation of solid-liquid separation, re-dispersing the dehydrated toner cake in ion-exchanged water and solid-liquid separation was repeated three times, and then dried at 40° C. for 24 hours to obtain toner mother particles. 1 mass % of hydrophobic silica (number average primary particle size: 12 nm) and 0.3 mass % of hydrophobic titania (number average primary particle size: 20 nm) were added to the obtained toner mother particles. Toner particles 3 were obtained by adding 1 mass % of hydrophobic silica (number average primary particle size: 12 nm) and 0.3 mass % of hydrophobic titania (number average primary particle size: 20 nm) and mixing using a Henschel Mixer (registered trademark).

### <Preparation of Toner Particles 4>

Toner particles 4 were prepared in the same manner as in the preparation of the toner particles 3, except for the following change was done. The compound (A1)-containing styrene-acrylic resin particle dispersion (S1) was changed to 50.1 mass parts (solid content conversion), and the compound (A1) particle dispersion was changed to 49.9 mass parts (solid content conversion).

### <Preparation of Toner Particles 5>

Toner particles 5 were prepared in the same manner as in the preparation of the toner particles 3, except for the following change was done. The compound (A1)-containing styrene-acrylic resin particle dispersion (S1) was changed to 39.1 mass parts (solid content conversion), and the compound (A1) particle dispersion was changed to 60.9 mass parts (solid content conversion).

### <Preparation of Toner Particles 6>

Toner particles 6 were prepared in the same manner as in the preparation of the toner particles 3, except for the following change was done. The compound (A1)-containing styrene-acrylic resin particle dispersion (S1) was changed to the compound (A2)-containing styrene-acrylic resin particle dispersion (S2), and the compound (A1) particle dispersion was changed to the compound (A2) particle dispersion.

### <Preparation of Toner Particles 7>

Toner particles 7 were prepared in the same manner as in the preparation of the toner particles 3, except for the following change was done. The compound (A1)-containing styrene-acrylic resin particle dispersion (S1) was changed to the compound (A3)-containing styrene-acrylic resin particle dispersion (S3), and the compound (A1) particle dispersion was changed to the compound (A3) particle dispersion.

### <Preparation of Toner Particles 8>

In a reaction vessel equipped with a stirrer, a temperature sensor, and a cooling tube, 89.5 mass parts (converted to solid content) of styrene-acrylic resin particle dispersion (S4) and 400 mass parts of ion-exchanged water were charged. Then, 5 mol/L sodium hydroxide aqueous solution was added under stirring at 150 rpm, and pH (25° C. conversion) was adjusted to 10. Thereafter, 5 mass parts (in terms of solid content) of the colorant particle dispersion (Bk1) was added, and then an aqueous solution in which 15 mass parts of magnesium chloride was dissolved in 15 mass parts of ion-exchanged water was stirred at 150 rpm at 30° C. and added over 10 minutes. After leaving this system for 3 minutes, the temperature was raised to 70° C. over 60 minutes with stirring at 200 rpm. Thereafter, 10.5 mass parts of the polymer (A5′) particle dispersion (solid content conversion) were added over 20 minutes while maintaining 70° C. The particle growth reaction was continued while maintaining 70° C. In this state, the particle size of the associated particles was measured with “COULTER MULTISIZER 3” (manufactured by Coulter Beckman), and when the volume-based median diameter (D50) became 6.5 μm, particle growth was stopped by adding an aqueous solution in which 20 mass parts of sodium chloride was dissolved in 80 mass parts of ion-exchanged water. After maintaining in this state for 2 hours, the temperature was lowered to 50° C. over 30 minutes, and the mixture was further stirred for 1 hour at 300 rpm, thereby forming a domain of the polymer (A5′). Then, the system was cooled to 30° C. over 60 minutes. Next, the operation of solid-liquid separation, re-dispersing the dehydrated toner cake in ion-exchanged water and solid-liquid separation was repeated three times, and then dried at 40° C. for 24 hours to obtain toner mother particles. 1 mass % of hydrophobic silica (number average primary particle size: 12 nm) and 0.3 mass % of hydrophobic titania (number average primary particle size: 20 nm) were added to the obtained toner mother particles. Toner particles 8 were obtained by adding 1 mass % of hydrophobic silica (number average primary particle size: 12 nm) and 0.3 mass % of hydrophobic titania (number average primary particle size: 20 nm) and mixing using a Henschel Mixer (registered trademark).

### <Preparation of Toner Particles 9>

Toner particles 9 were prepared in the same manner as in the preparation of the toner particles 8, except for the following change was done. The styrene-acrylic resin particle dispersion (S4) was changed to 68.5 mass parts (solid content conversion) and 31.5 mass parts (solid content conversion) of the polymer (A5′) particle dispersion.

### <Preparation of Toner Particles 10>

In a reaction vessel equipped with a stirrer, a temperature sensor, and a cooling tube, 68.5 mass parts (converted to solid content) of styrene-acrylic resin particle dispersion (S4), 31.5 mass parts (solid content conversion) of the compound (A1) particle dispersion, 400 mass parts of ion-exchanged water, and the colorant particle dispersion (Bk1) were charged. Then, while keeping the inner temperature of the vessel to 30° C., 5 mol/L sodium hydroxide aqueous solution was added, and pH was adjusted to 10. Next, an aqueous solution in which 2 mass parts of magnesium chloride was dissolved in 15 mass parts of ion-exchanged water was added over 10 minutes at 30° C. with stirring at 150 rpm. The system was allowed to stand for 3 minutes, then dropped at 200 rpm with stirring for 10 minutes, and then the temperature was raised. The system was heated to 70° C. over 60 minutes, and the particle growth reaction was continued while maintaining 70° C. In this state, the particle size of the associated particles was measured with “COULTER MULTISIZER 3” (manufactured by Coulter Beckman), and when the volume-based median diameter (D50) became 6.5 μm, particle growth was stopped by adding an aqueous solution in which 20 mass parts of sodium chloride was dissolved in 80 mass parts of ion-exchanged water. After stirring at 70° C. for 1 hour, the temperature was further raised, and the particles were allowed to progress by fusing for 1 hour at 75° C., followed by cooling to 30° C. at a rate of 20° C./min. Next, the operation of solid-liquid separation, re-dispersing the dehydrated toner cake in ion-exchanged water and solid-liquid separation was repeated three times, and then dried at 40° C. for 24 hours to obtain toner mother particles 1 mass % of hydrophobic silica (number average primary particle size: 12 nm) and 0.3 mass % of hydrophobic titania (number average primary particle size: 20 nm) were added to the obtained toner mother particles. Toner particles 10 were obtained by adding 1 mass % of hydrophobic silica (number average primary particle size: 12 nm) and 0.3 mass % of hydrophobic titania (number average primary particle size: 20 nm) and mixing using a Henschel Mixer (registered trademark).

### <Preparation of Toner Particles 11>

Toner particles 11 were prepared in the same manner as in the preparation of the toner particles 10 except that the compound (A1) particle dispersion was changed to the compound (A4) particle dispersion.

### <Preparation of Toner Particles 12>

Toner particles 12 were prepared in the same manner as in the preparation of the toner particles 10 except that the compound (A1) particle dispersion was changed to the polymer (A5′) particle dispersion.

For each toner particle prepared above, the area of the domain present in the toner particle was calculated after observing the cross section of the toner particle by the following method, and the result is indicated in Table I below.

### <<1. Method for Preparing a Section of Toner Particles>>

A toner is exposed for 10 minutes in a ruthenium tetroxide (RuO₄) vapor atmosphere, and then the toner is buried in a photocurable resin “D-800” (manufactured by JEOL Ltd.). A photo-cured block is formed by this. Then, using a microtome provided with diamond cutter, a thin sample having a thickness of 60 to 100 nm is cut out from the formed block. This thin sample is placed on a grid with a support membrane for transmission electron microscope observation. A filter paper is put on a 5 cmφ plastic petri dish, and the grid having the section is placed on the plastic petri dish with the side on which the section is placed facing upward.

### <<2. Ruthenium Tetroxide Staining Conditions>>

When it is required, staining is performed. The staining conditions (time, temperature, concentration and amount of the staining agent) are adjusted so that each component (mainly an amorphous resin and a compound that undergoes phase transition) can be distinguished during observation with a transmission electron microscope. For example, 2 to 3 drops of 0.5 mass % RuO₄ staining solution is dropped on two points in the petri dish, covered, and after 10 minutes, the petri dish lid is removed and left until the staining liquid is free of moisture.

### <<3. Cross-Sectional Observation Method (Conditions) of Toner Particles>>

Apparatus: Scanning electron microscope “JSM-7401F” (manufactured by JEOL Ltd.);

Sample: Toner particle section (section thickness of about 100 nm); and

Observation conditions: Acceleration voltage 30 kV, transmission image mode, bright field image, magnification 10,000 times.

### [Preparation of Developer]

9.5 g of a carrier having a volume-based median diameter of 70 μm and 0.5 g of each of the obtained toners are put into a 20 ml glass container. The container was shaken 200 times per minute at a swing angle of 45 degrees with an arm of 50 cm length for 20 minutes, thus each developer was prepared.

### [Evaluation]

### <Fixability Test>

The fixability test was performed in a normal temperature and humidity environment (temperature 20° C., humidity 50 % RH) using the developer obtained above. While sliding the developer by magnetic force, the developer was placed between a pair of parallel plate (aluminum) electrodes with the developer on one side and coated paper POD gloss coat (128 g/m²) (made by Oji Paper Co., Ltd.) on the other side. The toner was developed under the condition that the gap between the electrodes is 0.5 mm, the DC bias and the AC bias were set so that the toner adhesion amount is 4.0 g/m². The toner layer was formed on the surface of the paper, and the printed matter was fixed by the fixing device. The fixing conditions were as follows: the wavelength of the ultraviolet light irradiated from the irradiation unit was 365 nm (light source: LED light source having an emission wavelength of 365 nm±10 nm), and the irradiation amount was 8 J/cm².

### <Rubbing Fixing Rate>

The 1 cm square toner image of the printed material was rubbed 10 times with “JK Wiper (registered trademark)” (manufactured by Nippon Paper Crecia Co., Ltd.) under a pressure of 30 kPa, and the image fixing rate was evaluated. A fixing rate of 80% or more was considered acceptable. The image fixing rate was determined as follows. The reflection density of the image after printing and the reflection density of the image after rubbing were measured with a fluorescence spectral densitometer “FD-7” (manufactured by Konica Minolta Co., Ltd.). The image fixing rate is a numerical value expressed as a percentage obtained by dividing the reflection density of the solid image after rubbing by the reflection density of the solid image after printing. The image fixing rate was measured in a normal temperature and humidity environment (temperature 20° C., relative humidity 50% RH).

### <Folding Fixability>

The 1 cm square toner image of the printed material was folded with a folding machine so as to apply a load, and compressed air of 0.35 MPa was sprayed. The crease portion was ranked according to the following evaluation criteria.
5: There are no creases at all.
4: There is peeling according to some creases.
3: There is fine line peeling along the crease.
2: There is thick linear peeling along the crease.
1: There is large peeling along the crease.

TABLE I

| | Compound (A) | | Polymer (A′) | | | | | |
|---|---|---|---|---|---|---|---|---|
| | | Introduced | | Introduced | | | | |
| | | amount | | amount | | Fixing strength | | |
| | | relative to | | relative to | | Rubbing | | |
| | | toner mother | | toner mother | Domain | fixing | | |
| Toner | | particles | | particles | area ratio | rate | Folding | |
| No. | No | (mass %) | No. | (mass %) | (%) | (%) | fixability (%) | Remarks |
| 1 | A1 | 5 | — | — | 0.7 | 80 | 3 | Present invention |
| 2 | A1 | 5 | — | — | 1.0 | 85 | 3 | Present invention |
| 3 | A1 | 30 | — | — | 25 | 98 | 5 | Present invention |
| 4 | A1 | 50 | — | — | 50 | 95 | 4 | Present invention |
| 5 | A1 | 60 | — | — | 56 | 93 | 3 | Present invention |
| 6 | A2 | 30 | — | — | 10 | 92 | 4 | Present invention |
| 7 | A3 | 30 | — | — | 30 | 97 | 4 | Present invention |
| 8 | — | — | A5′ | 10 | 5 | 86 | 5 | Present invention |
| 9 | — | — | A5′ | 30 | 15 | 98 | 5 | Present invention |
| 10 | A1 | 30 | — | — | Absent | 75 | 2 | Comparative example |
| 11 | A4 | 30 | — | — | Absent | 20 | 1 | Comparative example |
| 12 | — | — | A5′ | 30 | Absent | 71 | 2 | Comparative example |

As demonstrated in the above results, it can be seen that the toner of the present invention has a high rubbing fixing rate and excellent folding fixability as compared with the toner of the comparative example.

Although the embodiments of the present invention have been described and illustrated in detail, the disclosed embodiments are made for purpose of illustration and example only and not limitation. The scope of the present invention should be interpreted by terms of the appended claims.

What is claimed is:

1. An electrostatic image developing toner comprising toner particles,
wherein the toner particles contain a compound (A) that undergoes a phase transition from a solid to a liquid by absorbing light, or contain a polymer (A′) containing a structural unit derived from the compound (A); and
a part or all of a site derived from the compound (A) is included in a domain in the toner particles and exists as a domain.

2. The electrostatic image developing toner described in claim 1,
wherein an area of the domain is in the range of 1 to 50% with respect to a cross-sectional area of the toner particles when a cross section image of the toner particles is observed.

3. The electrostatic image developing toner described in claim 1,
wherein the toner particles further contain a binder resin; and
the binder resin contains a styrene-acrylic resin.

4. The electrostatic image developing toner described in claim 1,
wherein the compound (A) is an azobenzene derivative.

5. An image forming method using an electrostatic image developing toner described in claim 1, comprising the steps of:
forming a toner image with the electrostatic image developing toner on a recording medium; and
irradiating the toner image with light to soften the toner image.

6. The image forming method described in claim 5,
wherein the light has a wavelength in the range of 280 to 480 nm.
